(19) United States
(12) Patent Application Publication
(10) Pub. No.: US 2026/0100203 A1
(43) Pub. Date: Apr. 9, 2026

(54) SYSTEMS AND METHODS FOR AUTOMATED MOVIE GENERATION AND EDITING

(71) Applicant: Meta Platforms, Inc., Menlo Park, CA (US)

(72) Inventors: Zecheng He, Mountain View, CA (US); Samaneh Azadi, Belmont, CA (US); Bowen Shi, Jersey City, NJ (US); Apoorv Vyas, Redwood City, CA (US); Ann Lee, New York, NY (US); Ishan Satish Misra, Seattle, WA (US); Peizhao Zhang, Los Altos, CA (US); Roshan Rajesh Sumbaly, Sunnyvale, CA (US); Yaniv Nechemia Taigman, Raanana (IL); Peter Vajda, Menlo Park, CA (US); Yi-Chiao Wu, Long Island City, NY (US); Andros Tjandra, Jersey City, NJ (US); Wei-Ning Hsu, Long Island City, NY (US); Amit Zohar, Tel Aviv (IL); Animesh Sinha, San Francisco, CA (US); Yuval Kirstain, Mountain View, CA (US); Shelly Sheynin, Tel Aviv (IL); Adam Polyak, Tel Aviv (IL); Matthew Le, Irvington, NY (US); Juefei Xu, Jersey City, NJ (US); Haoyu Ma, Newark, CA (US); Tingbo Hou, Menlo Park, CA (US)

(21) Appl. No.: 19/348,769

(22) Filed: Oct. 2, 2025

Related U.S. Application Data
(60) Provisional application No. 63/703,009, filed on Oct. 3, 2024.

(51) Int. Cl. G11B 27/031

(52) U.S. Cl. CPC G11B 27/031

(57) ABSTRACT

A method to edit a video includes receiving an input video including a sequence of frames and receiving an editing instruction expressed in natural language. The method also includes generating a multimodal condition based on the textual editing instruction and the input video. The multimodal condition may include an embedding of the input video concatenated with an embedding of the textual editing instruction. The method also includes applying, via a video editing model, the multimodal condition to modify visual content of the input video. The method further includes generating an edited video including visual modifications corresponding to the textual editing instruction. The edited video preserves temporal coherence and overall visual fidelity of the input video.

### CROSS-REFERENCE TO RELATED APPLICATIONS

This application claims priority to U.S. Provisional Application No. 63/703,009, filed Oct. 3, 2024, entitled, “SYSTEMS AND METHODS FOR AUTOMATED MOVIE GENERATION AND EDITING,” the content of which is incorporated by reference herein in its entirety.

### TECHNOLOGICAL FIELD

The present disclosure generally relates to methods, apparatuses, and computer program products for automated generation and editing of digital media, including video and audio content, using large-scale machine learning models.

### BRIEF DESCRIPTION

Advances in artificial intelligence have enabled generative models to create and manipulate digital media across multiple modalities. Early work focused on text-to-image synthesis, using architectures such as diffusion models and generative adversarial networks to produce photorealistic images from natural language prompts. Research has since expanded into text-to-video generation, where models adapt image-based frameworks to handle temporal information and maintain consistency across frames. Parallel efforts explore video editing, including natural language interfaces and techniques that reduce reliance on paired training data through proxy tasks or transfer learning. Generative audio systems have likewise advanced from text-to-speech to large-scale models that can produce music, sound effects, and synchronized audio for video content.

At the architectural level, large transformer-based foundation models are used for multimodal tasks. By scaling model parameters, training data, and context length, these transformer-based foundation models capture complex cross-modal relationships and support video generation, editing, and audio synthesis within a unified framework.

### SUMMARY

Various systems, methods, and devices are described to generate, edit, and synthesize digital media using large-scale machine learning models, including text-to-video generation, instruction-based video editing, and synchronized audio production.

In some aspects of the present disclosure, a method to generate a video includes receiving a user input that provides a description of a desired video. The method also includes generating, based on the user input, a structured script that may include scene descriptions, dialogue, or explicit shot-level information. The method further includes generating, from the structured script, a sequence of video frames representing one or more scenes, and generating an audio track based on the structured script and the sequence of video frames. The audio track including ambient sounds, sound effects, or music that is temporally synchronized with the sequence of video frames. The method also includes combining the sequence of video frames with the audio track to produce a synchronized video output corresponding to the desired video.

In some aspects of the present disclosure, an apparatus is provided. The apparatus may include one or more processors and a memory including computer program code instructions. The memory and computer program code instructions are configured to, with at least one of the processors, cause the apparatus to at least perform operations including receiving a user input comprising a description of a desired video. The memory and computer program code are also configured to, with the processor(s), cause the apparatus to generate, based on the user input prompt, a structured script comprising one or more of scene descriptions, dialogue, or explicit shot-level information. The memory and computer program code are also configured to, with the processor(s), cause the apparatus to generate, based on the structured script, a sequence of video frames representing one or more scenes. The memory and computer program code are also configured to, with the processor(s), cause the apparatus to generate, based on the structured script and the sequence of video frames, an audio track comprising one or more of ambient sounds, sound effects, or music. The generated audio track being temporally synchronized with the sequence of video frames. The memory and computer program code are also configured to, with the processor(s), cause the apparatus to combine the sequence of video frames with the audio track to generate a synchronized video output representing the desired video.

Other aspects of the present disclosure are directed to an apparatus. The apparatus includes means for receiving a user input describing a desired video, means for generating a structured script including scene descriptions, dialogue, or shot-level information, means for generating a sequence of video frames from the structured script, means for generating an audio track based on the structured script and video frames such that the audio track is temporally synchronized with the video frames, and means for combining the video frames with the audio track to generate a synchronized video output.

In other aspects of the present disclosure, a non-transitory computer-readable medium with program code recorded thereon is disclosed. The program code is executed by one or more processors and includes program code to receive a user input describing a desired video, to generate a structured script including scene descriptions, dialogue, or shot-level information, to generate a sequence of video frames from the structured script, to generate a temporally synchronized audio track including ambient sounds, sound effects, or music based on the structured script and video frames, and to combine the video frames and audio track to generate a synchronized video output.

Other aspects of the present disclosure are directed to a video generation system. The system includes one or more processors and one or more memories coupled with the one or more processors. The memory stores processor-executable code that, when executed, causes the system to receive a user input describing a desired video, to generate a structured script, to generate a sequence of video frames from the structured script, to generate a temporally synchronized audio track based on the structured script and video frames, and to combine the video frames and audio track into a synchronized video output.

In some aspects, a method for generating a video includes receiving an input describing a scene and receiving a reference image depicting a character. The method also includes generating, via an encoder, embeddings of identity features of the reference image. The method further includes generating, via a video generation model, a video in which the character appears with consistent likeness across multiple frames, the video being generated in accordance with the embeddings and the scene description.

Other aspects are directed to an apparatus. The apparatus includes means for receiving a scene description and a reference image of a character, means for generating identity embeddings of the reference image via an encoder, and means for generating, via a video generation model, a video with consistent likeness of the character across multiple frames in accordance with the embeddings and the scene description.

Other aspects are directed to a non-transitory computer-readable medium. The medium includes program code that, when executed, causes one or more processors to receive a scene description and a reference image, to generate embeddings of identity features of the reference image via an encoder, and to generate, via a video generation model, a video depicting the character with consistent likeness across multiple frames.

Other aspects are directed to a video generation system including one or more processors and one or more memories storing instructions that cause the processors to receive a scene description and reference image, to generate embeddings of identity features, and to generate a video with consistent likeness of the character across frames in accordance with the embeddings and scene description.

In some aspects, a method for editing a video includes receiving an input video comprising a sequence of frames and receiving an editing instruction expressed in natural language. The method further includes generating a multimodal condition that combines an embedding of the input video with an embedding of the editing instruction. The method also includes applying, via a video editing model, the multimodal condition to modify visual content of the input video, and generating an edited video that preserves temporal coherence and visual fidelity while reflecting the requested modifications.

Other aspects are directed to an apparatus. The apparatus includes means for receiving an input video and natural language editing instruction, means for generating a multimodal condition comprising embeddings of the input video and the instruction, means for applying the multimodal condition via a video editing model to modify the video, and means for generating an edited video that reflects the editing instruction while preserving coherence and fidelity.

Other aspects are directed to a non-transitory computer-readable medium. The medium includes program code that, when executed, causes one or more processors to receive an input video and natural language editing instruction, generate a multimodal condition, apply the multimodal condition to modify the video, and output an edited video that preserves temporal coherence and visual fidelity.

Other aspects are directed to a video editing system comprising one or more processors and one or more memories configured to store instructions that cause the processors to receive an input video and editing instruction, generate a multimodal condition, apply a video editing model, and output an edited video with modifications consistent with the instruction.

In some aspects, a method for generating synchronized audio for a video includes receiving a video comprising a sequence of frames and receiving a text input describing a scene, event, or mood to be reflected in an audio track. The method further includes generating a latent audio representation via an audio generation model conditioned jointly on video embeddings derived from the sequence of frames and text embeddings derived from the text input. The method also includes decoding the latent audio representation to produce an audio track that is temporally aligned with the video and semantically consistent with the text input.

Other aspects are directed to an apparatus. The apparatus includes means for receiving a video sequence and text input, means for generating video embeddings and text embeddings, means for generating a latent audio representation via an audio generation model conditioned on the embeddings, and means for decoding the latent representation into a temporally aligned audio track.

Other aspects are directed to a non-transitory computer-readable medium. The medium includes program code that, when executed, causes one or more processors to receive a video and text input, generate video and text embeddings, generate a latent audio representation conditioned on the embeddings, and decode the latent representation into an audio track synchronized with the video.

Other aspects are directed to a system for audio-video synchronization. The system includes one or more processors and one or more memories configured to store instructions that cause the processors to receive a video and text input, generate embeddings, create a latent audio representation via an audio generation model, and decode the representation into an audio track temporally aligned with the video and semantically consistent with the input.

In some aspects, a video generation model may include a 30 billion (30B) parameter transformer trained with a maximum context length of 73,000 (73K) video tokens, corresponding to a generated video of 16 seconds at 16 frames-per-second. In some embodiments, the systems described herein may improve upon traditional architecture, latent spaces, training objectives and recipes, licensed data curation, evaluation protocols, parallelization techniques, and/or inference optimizations and thereby enable the systems described herein to reap the benefits of scaling pre-training data, model size, and/or training compute for training large scale media generation models.

In some aspects, the systems described herein may include a method for generating videos using a given reference identity with high identity preservation, prompt alignment, and visual quality. The systems described herein may also introduce an end-to-end automatic pipeline to generate a short movie with a consistent character. For example, a user may provide one or more reference images of a person, and the systems described herein may generate a movie featuring the person. In some examples, the systems described herein may not rely on text-based prompts to show the same person in each scene but may instead use the picture or pictures provided. In one embodiment, the systems described herein may, given a reference image, first extract the face feature, then inject the face feature into a model using a cross-attention technique. In some embodiments, the systems described herein may generate movies featuring a consistent character or characters that are not a person, such as animals, animated figures, inanimate objects, etc.

In some aspects, the systems described herein may use text-based models such as large language models (LLMs) to automatically generate movies with consistent character development, plot, and/or visual style. For example, the systems described herein may generate a script with an LLM, then utilize an image generation model to generate a human subject and use this reference image as conditioning in the video model to produce a video for each scene. The systems described herein may then edit the videos and stitch the videos together in the same order as the script generated by the LLM.

In some aspects, the systems described herein may perform video-to-audio generation with text control. In some examples, the systems described herein may include models with nine, 13, or even 20 billion parameters or more. In order to train and execute such large models, the systems described herein may use data parallelization to distribute parameters into different models and/or may pre-compute features to reduce training time.

In some aspects, the systems described herein may produce end-to-end movie-like audio generation, such as full soundtrack generation with specified sound events, sound effects, music genre and/or mood, all synchronized to visual scenes. In one embodiment, the systems described herein may generate multiple types of audio (e.g., sound effects and music) via a single audio generation model. Generating multiple types of audio with a single model may enable the systems described herein to synergize different types of generation to produce a comprehensive soundtrack.

In some aspects, the systems described herein may make the audio generation controllable via text. For example, the systems described herein may enable direct control of model-estimated audio quality via text and/or both onscreen and off-screen sound generation based on text prompts.

In some aspects, the systems described herein may generate audio for long videos without duration constraint. In one embodiment, the systems described herein may utilize segmental reranking and/or adapted multi-diffusion for audio generation.

In some aspects, the systems described herein may use mixed modal training by training a model on the combination of audio-video and audio-only data, resulting in a single model that can perform text- and/or video-to-audio generation. In some examples, the systems described herein may output high-fidelity audio, such as 48 kilohertz (kHz), for video-to-audio generation. In some examples, the systems described herein may improve audio quality and/or model quality by reranking based on audio-video alignment signal and/or a combination of signals (e.g., audio-video alignment and audio quality).

In some aspects, the systems described herein may implement reward training. For example, an external model may provide a signal to the audio generation model that is used to guide the training process. This may allow the model to be more aligned with the signal provider. This signal provider may be related to aspects of the model output, such as video-audio alignment or audio quality.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the disclosed subject matter; however, the disclosed subject matter is not limited to the specific methods, compositions, and devices disclosed. In addition, the drawings are not necessarily drawn to scale. In the drawings:

FIG. 1 is a block diagram of a system, in accordance with various aspects of the present disclosure.

FIG. 2 illustrates a block diagram of an exemplary hardware/software architecture of a communication device, such as, for example, user equipment (UE) 30, in accordance with various aspects of the present disclosure.

FIG. 3 is a block diagram of an exemplary computing system 300, in accordance with various aspects of the present disclosure.

FIG. 4 illustrates an example training pipeline for a movie gen video model, in accordance with various aspects of the present disclosure.

FIG. 5 illustrates an example of a joint image and video generation pipeline, in accordance with various aspects of the present disclosure.

FIG. 6 illustrates an example pipeline for variable-length video encoding and decoding using a temporal autoencoder (TAE), in accordance with various aspects of the present disclosure.

FIG. 7 illustrates an example pipeline for tiled inference using a temporal autoencoder (TAE), in accordance with various aspects of the present disclosure.

FIG. 8 illustrates an overview of a spatial upsampler pipeline, in accordance with various aspects of the present disclosure.

FIG. 9 illustrates an example transformer backbone for a movie gen video model, in accordance with various aspects of the present disclosure.

FIG. 10 illustrates an example data curation pipeline for preparing video training data, in accordance with various aspects of the present disclosure.

FIG. 11 illustrates an example architecture and inference pipeline for a personalized text-to-video (PT2V) model, in accordance with various aspects of the present disclosure.

FIG. 12 illustrates an example training pipeline for a text-guided video editing model, in accordance with various aspects of the present disclosure.

FIG. 13 illustrates an example audio extension pipeline for generating long-form audio tracks synchronized with video content, in accordance with various aspects of the present disclosure.

FIG. 14 illustrates an example architecture of a movie gen audio model configured to generate soundtracks conditioned on multimodal inputs, in accordance with various aspects of the present disclosure.

FIG. 15 is a flow diagram illustrating an example of a process for end-to-end script-to-movie generation, in accordance with various aspects of the present disclosure.

FIG. 16 is a flow diagram illustrating an example of a process for maintaining consistent character identity across generated video scenes, in accordance with various aspects of the present disclosure.

FIG. 17 is a flow diagram illustrating an example of a process for performing unsupervised instruction-based video editing, in accordance with various aspects of the present disclosure.

FIG. 18 is a flow diagram illustrating an example of a process for unified audio generation from text and video inputs, in accordance with various aspects of the present disclosure.

FIG. 19 illustrates a machine learning and training model, in accordance with various aspects of the present disclosure.

The figures depict various examples for purposes of illustration only. One skilled in the art will readily recognize from the following discussion that alternative examples of the structures and methods illustrated herein may be employed without departing from the principles described herein.

### DETAILED DESCRIPTION

Some examples of the present invention will now be described more fully hereinafter with reference to the accompanying drawings, in which some, but not all examples of the invention are shown. Indeed, various examples of the invention may be embodied in many different forms and should not be construed as limited to the examples set forth herein. Like reference numerals refer to like elements throughout. As used herein, the terms “data,” “content,” “information” and similar terms may be used interchangeably to refer to data capable of being transmitted, received or stored in accordance with examples of the invention. Moreover, the term “exemplary”, as used herein, is not provided to convey any qualitative assessment, but instead merely to convey an illustration of an example. Thus, use of any such terms should not be taken to limit the spirit and scope of examples of the invention.

Electronic devices are constantly changing and evolving to provide the user with flexibility and adaptability. With increasing adaptability in electronic devices users are taking and maintaining their devices on their person during various everyday activities. This may lead to many users wanting to capture their environment to share with others. In some instances, users capturing their environment may be a form of self-expression. Research has shown that the best self-expression online relies on great visuals. Visual expression, in many cases, is deeply contextual, which may lead to users wanting more creative control over the assets (e.g., stickers, gifs, photos) users utilize to express themselves.

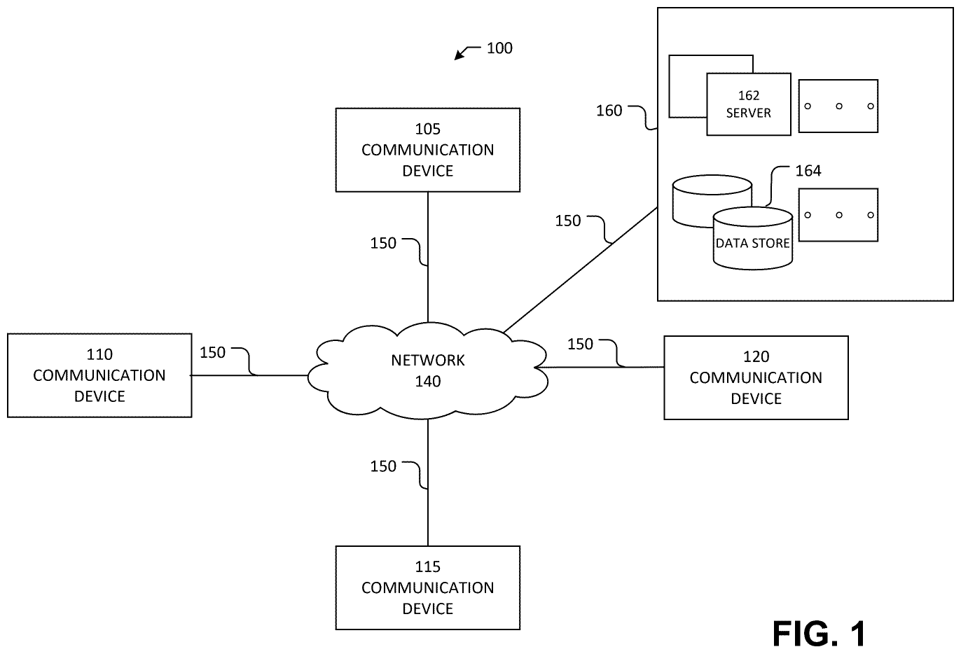

FIG. 1 is a block diagram of a system, in accordance with various aspects of the present disclosure. As shown in FIG. 1, the system 100 may include one or more communication devices 105, 110, 115, and 120 and a network device 160. Additionally, the system 100 may include any suitable network such as, for example, network 140. In some examples, the network 140. In other examples, the network 140 may be any suitable network capable of provisioning content and/or facilitating communications among entities within, or associated with the network 140. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 140 may include one or more networks 140.

Links 150 may connect the communication devices 105, 110, 115, and 120 to network 140, network device 160, and/or to each other. This disclosure contemplates any suitable links 150. In some exemplary embodiments, one or more links 150 may include one or more wired and/or wireless links, such as, for example, Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH). In some exemplary embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout system 100. One or more first links 150 may differ in one or more respects from one or more second links 150.

In some examples, communication devices 105, 110, 115, 120 may be electronic devices including hardware, software, or embedded logic components or a combination of two or more such components and capable of carrying out the appropriate functionalities implemented or supported by the communication devices 105, 110, 115, 120. As an example, and not by way of limitation, the communication devices 105, 110, 115, 120 may be a computer system such as, for example, a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 105, 110, 115, 120 may enable one or more users to access network 140. The communication devices 105, 110, 115, 120 may enable a user(s) to communicate with other users at other communication devices 105, 110, 115, 120.

Network device 160 may be accessed by the other components of system 100 either directly or via network 140. As an example and not by way of limitation, communication devices 105, 110, 115, 120 may access network device 160 using a web browser or a native application associated with network device 160 (e.g., a mobile social-networking application, a messaging application, another suitable application, or any combination thereof) either directly or via network 140. In particular exemplary embodiments, network device 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 162 may include hardware, software, or embedded logic components or a combination of two or more such components for carrying out the appropriate functionalities implemented and/or supported by server 162. In particular exemplary embodiments, network device 160 may include one or more data stores 164. Data stores 164 may be used to store various types of information. In particular exemplary embodiments, the information stored in data stores 164 may be organized according to specific data structures. In particular exemplary embodiments, each data store 164 may be a relational, columnar, correlation, or other suitable database. Although this disclosure describes or illustrates particular types of databases, this disclosure contemplates any suitable types of databases. Particular exemplary embodiments may provide interfaces that enable communication devices 105, 110, 115, 120, and/or another system (e.g., a third-party system) to manage, retrieve, modify, add, or delete the information stored in data store 164.

Network device 160 may provide users of the system 100 the ability to communicate and interact with other users. In particular exemplary embodiments, network device 160 may provide users with the ability to take actions on various types of items or objects, supported by network device 160. In particular exemplary embodiments, network device 160 may be capable of linking a variety of entities. As an example and not by way of limitation, network device 160 may enable users to interact with each other as well as receive content from other systems (e.g., third-party systems) or other entities, or allow users to interact with these entities through an application programming interfaces (API) or other communication channels.

It should be pointed out that although FIG. 1 shows one network device 160 and four communication devices 105, 110, 115 and 120, any suitable number of network devices 160 and communication devices 105, 110, 115 and 120 may be part of the system of FIG. 1 without departing from the spirit and scope of the present disclosure.

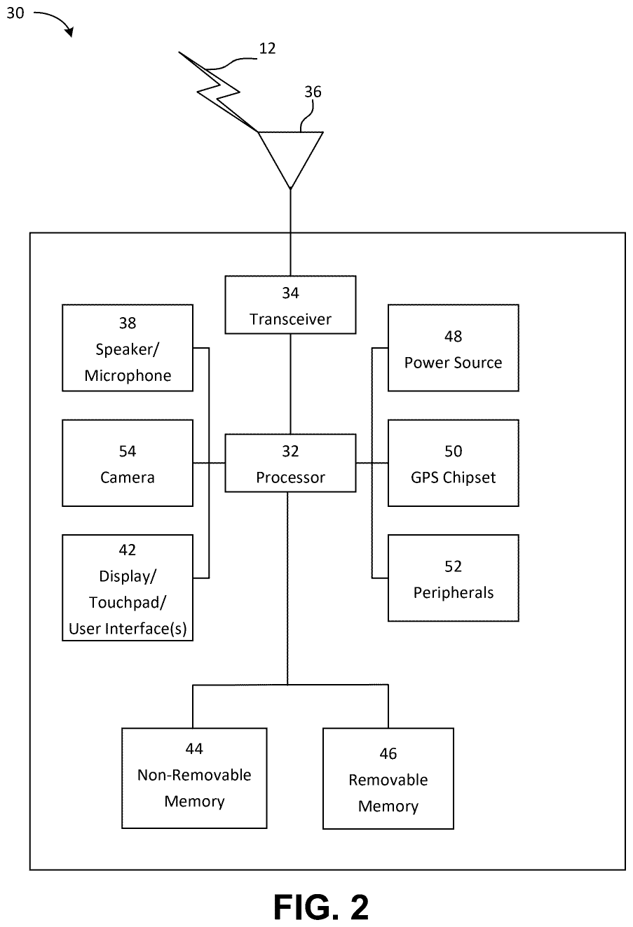

FIG. 2 illustrates a block diagram of an exemplary hardware/software architecture of a communication device such as, for example, user equipment (UE) 30, in accordance with various aspects of the present disclosure. In some exemplary respects, the UE 30 may be any of communication devices 105, 110, 115, 120. In some exemplary aspects, the UE 30 may be a computer system such as, for example, a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 2, the UE 30 (also referred to herein as node 30) may include a processor 32, non-removable memory 44, removable memory 46, a speaker/microphone 38, a display, touchpad, and/or user interface(s) 42, a power source 48, a GPS chipset 50, and other peripherals 52. In some exemplary aspects, the display, touchpad, and/or user interface(s) 42 may be referred to herein as display/touchpad/user interface(s) 42. The display/touchpad/user interface(s) 42 may include a user interface capable of presenting one or more content items and/or capturing input of one or more user interactions/actions associated with the user interface. The power source 48 may be capable of receiving electric power for supplying electric power to the UE 30. For example, the power source 48 may include an alternating current to direct current (AC-to-DC) converter allowing the power source 48 to be connected/plugged to an AC electrical receptacle and/or Universal Serial Bus (USB) port for receiving electric power. The UE 30 may also include a camera 54. In an exemplary embodiment, the camera 54 may be a smart camera configured to sense images/video appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., non-removable memory 44 and/or removable memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example. The non-removable memory 44 and/or the removable memory 46 may be computer-readable storage mediums. For example, the non-removable memory 44 may include a non-transitory computer-readable storage medium and a transitory computer-readable storage medium.

The processor 32 is coupled to its communication circuitry (e.g., transceiver 34 and transmit/receive element 36). The processor 32, through the execution of computer-executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, (e.g., non-removable memory 44 and/or removable memory 46) as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

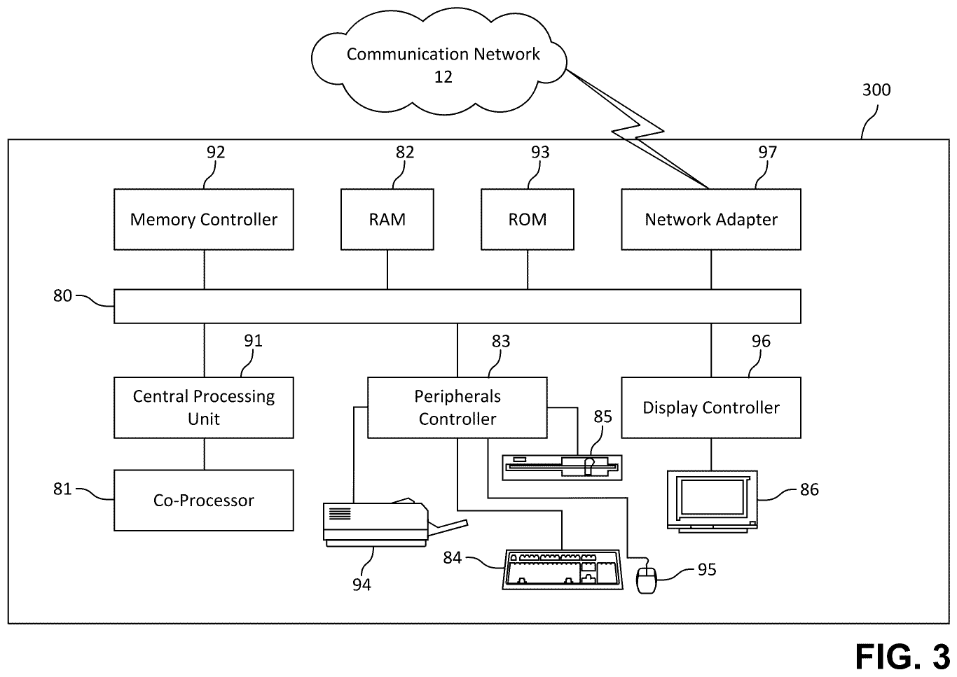

FIG. 3 is a block diagram of an exemplary computing system 300, in accordance with various aspects of the present disclosure. In some examples, the network device 160 may be a computing system 300. The computing system 300 may comprise a computer or server and may be controlled primarily by computer-readable instructions, which may be in the form of software, wherever, or by whatever means such software is stored or accessed. Such computer-readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 300 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 300 may contain peripherals controller 83 responsible for communicating instructions from CPU 91 to peripherals, such as printer 94, keyboard 84, mouse 95, and disk drive 85.

Display 86, which is controlled by display controller 96, may be used to display visual output generated by computing system 300. Such visual output may include text, graphics, animated graphics, and video. The display 86 may also include or be associated with a user interface. The user interface may be capable of presenting one or more content items and/or capturing input of one or more user interactions associated with the user interface. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 300 may contain communication circuitry, such as, for example, a network adapter 97, that may be used to connect computing system 300 to an external communications network, such as network 12 of FIG. 2, to enable the computing system 300 to communicate with other nodes (e.g., UE 30) of the network.

Advances in artificial intelligence and machine learning have enabled the development of increasingly sophisticated models for generating and manipulating digital media. Early generative models primarily focused on the production of still images from text prompts, often employing diffusion models, variational autoencoders, or generative adversarial networks. These approaches demonstrated the feasibility of producing photorealistic imagery conditioned on natural language input.

Subsequent research expanded from image synthesis to video synthesis. Text-to-video models have been proposed to generate short video clips from textual descriptions. Many of these systems adapt image-based generative frameworks to handle temporal information, such as by incorporating recurrent layers, temporal convolution, or attention-based mechanisms that operate across frames. Parallel efforts have sought to improve video generation quality by scaling model size, extending training data, and optimizing temporal consistency between frames.

In addition to generation, machine learning has also been applied to video editing. Conventional approaches often require paired training data in which input videos are aligned with desired edited outputs. More recent work has sought to reduce reliance on such supervised datasets by using proxy tasks, data augmentation strategies, or transfer learning from related domains such as image editing. Natural language-driven editing interfaces have also been explored to allow non-expert users to modify video content with simple textual instructions.

Generative audio models have developed in parallel with visual models. Early text-to-speech systems evolved into large-scale models capable of producing high-quality audio samples across multiple domains, including music, sound effects, and natural speech. Multimodal approaches have been investigated to synchronize generated audio with video, such as matching sound effects to actions or generating background music consistent with a visual scene.

At the architectural level, foundation models based on transformers have become the dominant framework for handling large-scale multimodal tasks. By increasing model parameters, context length, and training data diversity, such models can capture complex cross-modal relationships and support multiple downstream tasks from a single backbone. Techniques such as cross-attention, self-attention, and parallelized training pipelines have been leveraged to extend these models to longer sequences, higher resolutions, and richer modalities.

Despite rapid progress in generative modeling, current approaches to media creation remain fragmented and limited in scope. Text-to-image models typically produce only still images, while text-to-video models often generate very short clips with low resolution and limited temporal consistency. Existing video editing techniques frequently rely on large amounts of paired, manually labeled training data, making them expensive to develop and constrained in flexibility. Similarly, audio generation systems are usually specialized to a single task, such as text-to-speech or music generation, and lack the ability to jointly produce multiple types of synchronized audio for video. Moreover, few existing architectures scale effectively to long, high-quality video sequences, and there is no unified framework that integrates script generation, video synthesis, editing, and audio production into a single automated pipeline.

Various aspects of the present disclosure are directed to systems and methods for media generation using generative artificial intelligence (AI). In some examples, the systems generate photorealistic images and videos, including content that preserves a user's likeness derived from one or more reference images. The systems accept multimodal inputs, such as, but not limited to, text prompts, style descriptors, control signals, and example media, and generate outputs that align with those inputs while maintaining spatial and temporal coherence across frames and scenes. The systems may also support creation and editing operations driven by natural-language instructions, including transformations, replacements, insertions, and style changes.

In some examples, a foundation model may generate high-quality video with synchronized audio. The foundation model may render video, such as 1080p (e.g., 1080 progressive scan) video, at multiple aspect ratios (for example, 16:9, 9:16, and 1:1) and at selectable frame rates, and they compose or edit shots into longer sequences. The foundation model may also generate or edit content based on textual instructions, and personalize generated video by conditioning on a user's reference image to maintain character identity across shots. A unified audio component may generate music, sound effects, ambient tracks, or voice elements from text and/or video context and aligns those elements to visual events. Across tasks, the foundation model may perform text-to-image synthesis, text-to-video synthesis, video personalization, natural-language video editing, video-to-audio generation, and text-to-audio generation. The foundation model may integrate these capabilities within a single end-to-end pipeline.

The systems and methods described herein provide advantages over conventional approaches to media creation. The systems and methods may generate video, audio, and images at a scale, quality, and speed that cannot be achieved manually. For example, the systems may render high-resolution video with synchronized audio in seconds or minutes, whereas comparable manual production would require extensive time, expertise, and resources. The systems also maintain temporal and spatial consistency across scenes, which allows for the creation of long-form video content without frame-by-frame manual correction.

In some examples, the systems provide advantages in personalization and editing. For example, the systems may inject a user's likeness into generated content with high fidelity and maintain identity consistency across multiple clips. Human editors cannot replicate this process at a comparable speed or precision without repeated manual adjustments. Similarly, the systems may apply natural-language instructions to edit video, including transformations, replacements, or stylistic adjustments, without the need for specialized editing tools or technical expertise.

In some examples, the systems provide advantages in unified multimodal generation. A single foundation model may generate video, music, sound effects, and ambient audio in alignment with visual events. Human creators would require multiple distinct tools and substantial coordination to achieve the same result, and such efforts would not match the temporal precision or scalability of the disclosed systems. By integrating these capabilities into one automated pipeline, the systems enable consistent, efficient, and scalable production of complex media artifacts that cannot be replicated through manual processes.

For ease of explanation, the systems and methods of the present disclosure may refer to a movie generation model (also referred to as a movie gen model), which is a model that generates video from prompts. Examples of the input and output of the movie generation model may include, but are not limited to, the following. In some examples, the input may comprise a text prompt, such as a description of a subject or action, and the output may comprise a sequence of video frames that visually represent the prompt. For instance, a text prompt describing “a porcupine wearing a tutu, performing a ballet dance on a stage” may generate a video clip of the described scene. In another example, a prompt describing “a biker racing through the streets of Los Angeles” may generate a tracking shot video of a motorcyclist moving through a city environment.

In some examples, the input may comprise a reference image in combination with a text prompt. The system may use the reference image to preserve the likeness of the subject across multiple generated frames and scenes. For instance, a reference image of a person may be combined with a prompt such as “a person as a scientist performing an experiment with a test tube” to generate a video clip where the same individual appears consistently across multiple frames while performing the described activity.

In some examples, the input may comprise a source video together with a natural-language editing instruction. The system may output a modified video that reflects the requested transformation. For instance, a source video of a person releasing a lantern into the sky may be edited in response to an instruction to “add tinsel streamers to the lantern bottom,” producing a video in which the lantern includes the added visual element. Other examples of instruction-based editing may include transforming a lantern into a soaring bubble or changing the background of a scene from a natural setting to an urban or park environment.

In some examples, the input may comprise a video clip or text prompt describing an audio event, and the output may comprise synchronized audio tracks that align with visual content. For instance, a video of a diver entering a pool may be paired with generated audio including a splash of water and a loud thud. In another example, a video of a lightning strike may be paired with generated audio of thunder and background music. In some cases, the system may also generate spectrogram representations corresponding to the synthesized audio.

In some examples, the movie gen model generates video with synchronized audio, supports identity-consistent personalization, and performs video editing. These capabilities arise from two foundation models: a video foundation model and an audio foundation model.

In some examples, a movie gen video foundation model includes a large number of parameters and jointly supports text-to-image and text-to-video generation. The model generates high-quality video, such as high-definition (HD) video clips, that follow a text prompt. The model may also generate high-quality still images and video in multiple aspect ratios, resolutions, and durations. The movie gen video foundation model undergoes joint pre-training on videos and images and learns about the visual world by observing large-scale video corpora. The pre-trained model demonstrates reasoning capabilities with respect to object motion, subject-object interactions, geometry, camera motion, and physics, and produces plausible motion across a wide range of concepts. To further refine its output, the model undergoes supervised finetuning on a smaller curated set of high-quality videos and captions, which improves motion fidelity and visual aesthetics.

In some examples, a movie gen audio foundation model includes a large quantity of parameters and supports both video-to-audio and text-to-audio generation. The model generates sound effects, such as 48 kHz high-quality cinematic sound effects, and music that synchronize with video content and follow input text prompts. The movie gen audio foundation model handles variable-length audio generation and extends audio sequences to produce coherent tracks for videos lasting several minutes. The movie gen audio foundation model undergoes pre-training on audio data and learns both physical associations, such as matching visual actions to sound effects, and psychological associations, such as generating music that matches the mood or emotion implied by a scene. The movie gen audio foundation model produces diegetic ambient sounds consistent with visual scenes, diegetic sound effects aligned with actions, and non-diegetic music that supports narrative tone. In some examples, the movie gen audio foundation model blends background music and effects in a professional manner. A supervised finetuning stage using curated text-audio and video-text-audio pairs improves overall fidelity and supports cinematic audio styles.

In some examples, additional capabilities extend the movie gen video model through post-training. A personalization stage allows the system to condition on both a text prompt and a reference image of a person to generate a personalized video. The model maintains the identity of the referenced person while following the actions or scenarios described in the prompt. The personalization stage leverages a subset of training videos containing humans and automatically constructed pairs of images, text, and corresponding video outputs.

In some examples, a video editing stage allows a user to apply natural-language instructions to modify real or generated videos. The editing stage performs transformations, insertions, replacements, or style changes consistent with the instructions and the original video. Because large-scale supervised video editing data is not readily available, the system uses novel unsupervised and synthetic training methods to train the editing model without requiring labeled editing datasets.

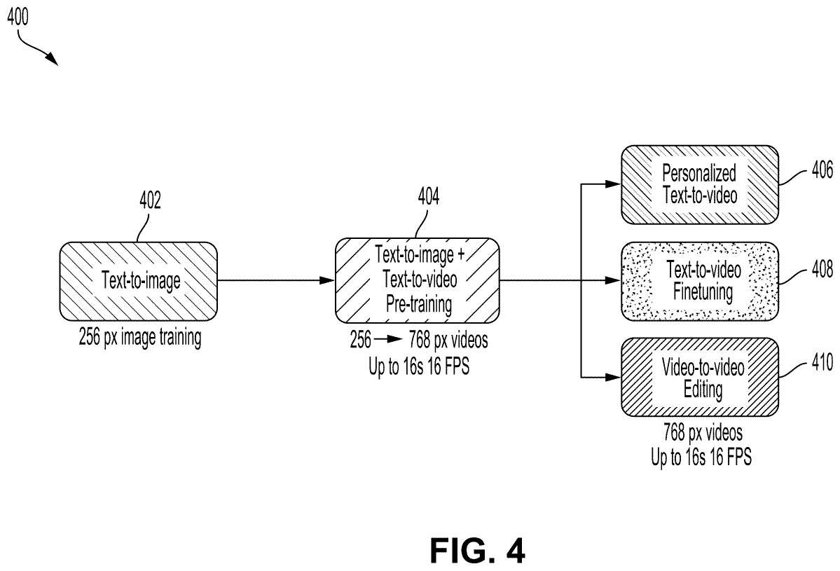

To implement the various capabilities disclosed herein, various aspects of the present disclosure use a staged training framework that incrementally builds core generation abilities and then extends them with specialized modules. FIG. 4 illustrates an example training pipeline 400 for a movie gen video model, in accordance with various aspects of the present disclosure. As shown in FIG. 4, the pipeline 400 organizes learning into an image-first stage, a joint image-video stage, and three post-training branches that add capabilities for personalization, quality refinement, and instruction-guided editing.

In a first stage 402, the pipeline 400 trains the model on a text-to-image task at 256-pixel resolution. The model receives text tokens as input and generates single-frame images as output. Because images are treated as single-frame videos, this stage establishes spatial understanding and builds cross-modal attention pathways that also support video generation. Paired image-text datasets scale more readily than video datasets and expose the model to diverse concepts and styles.

In a second stage 404, the pipeline 400 performs joint text-to-image and text-to-video pre-training. The training schedule expands from images to videos. For example, the pipeline 400 expands 256-pixel images to 768-pixel videos with various durations, such as, but not limited to, 16 seconds at 16 frames per second. The movie gen model learns temporal dynamics such as object motion, subject-object interactions, geometry, and camera motion, while retaining the ability to render single images. Training in a spatio-temporally compressed latent space improves efficiency. A temporal autoencoder (TAE) may map both images and videos into the latent space and back to the pixel domain, and a flow matching objective guides the generative process. Text encoders provide embeddings of user prompts as conditioning for the model.

From the joint pre-training stage 404, the pipeline 400 branches into three post-training paths. In a personalization path 406, the pipeline 400 conditions generation on both a text prompt and a reference image of a person. Training pairs may include a still image, an associated text description, and a target video of the same individual. The model learns to preserve identity features across frames and shots so that generated videos maintain the person's likeness while following the prompt.

In a quality refinement path 408, the pipeline 400 performs supervised finetuning on a curated set of high-aesthetic, high-motion-quality videos with captions. This stage sharpens details, improves temporal coherence, and aligns motion more closely with the intent of the text prompt. A spatial upsampler may further increase the output resolution, enabling the generation of high definition video, such as 1080p video.

In an editing path 410, the pipeline 400 enables video-to-video editing with natural-language instructions. The model accepts a source video and an instruction, such as add, replace, transform, or restyle, and outputs an edited video. For example, the edited video may have a 768-pixel resolution. Because large-scale supervised video editing data is limited, the training procedure may use synthetic and unsupervised methods to construct supervision, enabling the model to apply precise, localized edits that remain consistent with both the original content and the instruction.

The pipeline 400 in FIG. 4 trains the movie gen video model to support capabilities such as text-to-video generation, identity-consistent personalization, and instruction-guided video editing. A separate movie gen audio model may be trained to provide synchronized sound effects, music, and ambient audio, but does not appear in FIG. 4.

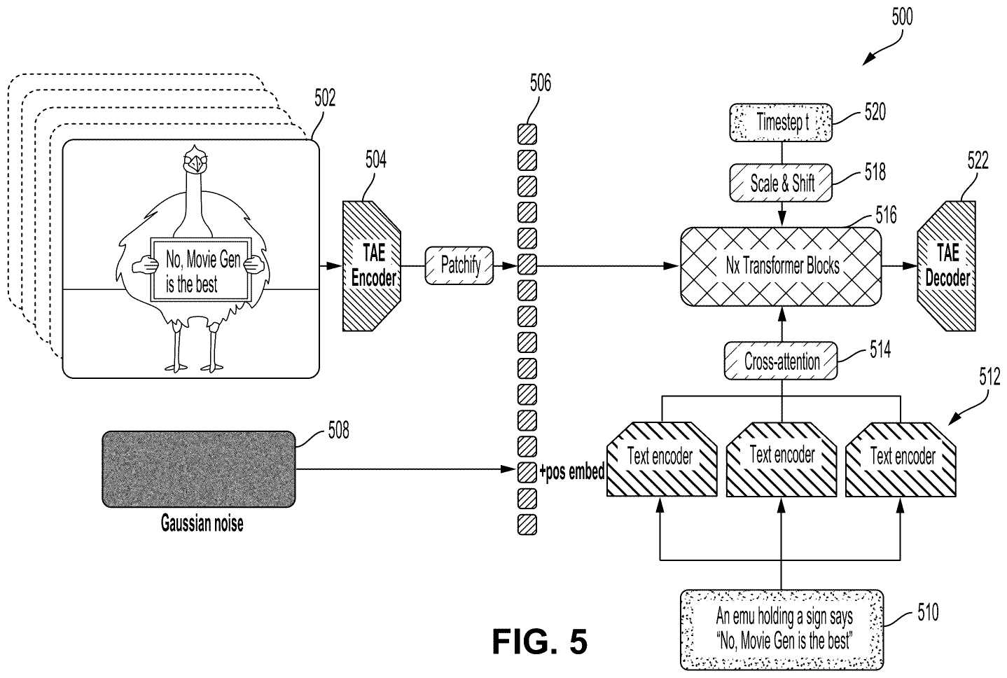

FIG. 5 illustrates an example of a joint image and video generation pipeline 500, in accordance with various aspects of the present disclosure. The pipeline 500 operates in a spatio-temporally compressed latent space learned by a temporal autoencoder (TAE), which improves training and inference efficiency while maintaining high-quality outputs. As shown in the example of FIG. 5, the pipeline 500 receives one or more input frames 502, which may include single-frame images or multi-frame video sequences. The frames 502 may be encoded by a TAE encoder 504 that compresses the spatial and temporal information into a latent representation. A patchification operation then divides the encoded representation into latent tokens 506 suitable for downstream processing. Additionally, the pipeline 500 may also introduce Gaussian noise 508, which is combined with the latent tokens 506 and positional embeddings to initialize the generative process. By progressively refining the noisy latent representations, the pipeline 500 produces realistic images and videos aligned with the user's conditioning inputs.

As shown in the example of FIG. 5, text prompts 510 provided by a user (e.g., user input) may be processed by one or more pre-trained text encoders 512, which may include large-scale vision-language models, such as, but not limited to, a contrastive language-image based LLM(s), a raw text bytes based LLM(s), or the like. The encoded text embeddings represent the semantic content of the prompt (e.g., “An emu holding a sign says ‘No, Movie Gen is the best’”) and are injected into the generative model through cross-attention modules 514. These cross-attention modules align the generated visual content with the text conditioning.

The latent tokens 506 and conditioning signals are processed by a sequence of transformer blocks 516, which form the backbone of the generative model. The transformer blocks 516 integrate the semantic conditioning, spatial-temporal structure, and stochastic input to iteratively refine the latent sequence. The process is further guided by timestep conditioning 520 and scale-and-shift operations 518, which regulate the generative trajectory in a manner consistent with flow matching or diffusion-style training objectives. The refined latent sequence is then decoded by a TAE decoder 522, which reconstructs an output in pixel space. Depending on the input, the decoder 522 produces either an image (for a single-frame input) or a video (for multi-frame input) that is consistent with the text prompt 510 and any other conditioning provided.

In some examples, the joint pipeline 500 trains a single foundation model, referred to herein as a movie gen video model, that supports both text-to-image and text-to-video tasks. By treating images as single-frame videos, the pipeline 500 leverages large-scale paired image-text datasets for efficient scaling and diversity while simultaneously learning temporal dynamics from video datasets. This joint training improves generalization across a wide range of visual concepts and styles.

The backbone architecture of the pipeline 500 may scale parameters, such as 30 billion parameters, and uses transformer-based architectures. The pipeline uses a flow matching training objective, which enables efficient sampling and refinement of latent representations. The movie gen video model directly generates video at multiple aspect ratios (e.g., 1:1, 9:16, 16:9) and various lengths at various resolutions, with an optional spatial upsampler that produces full HD output.

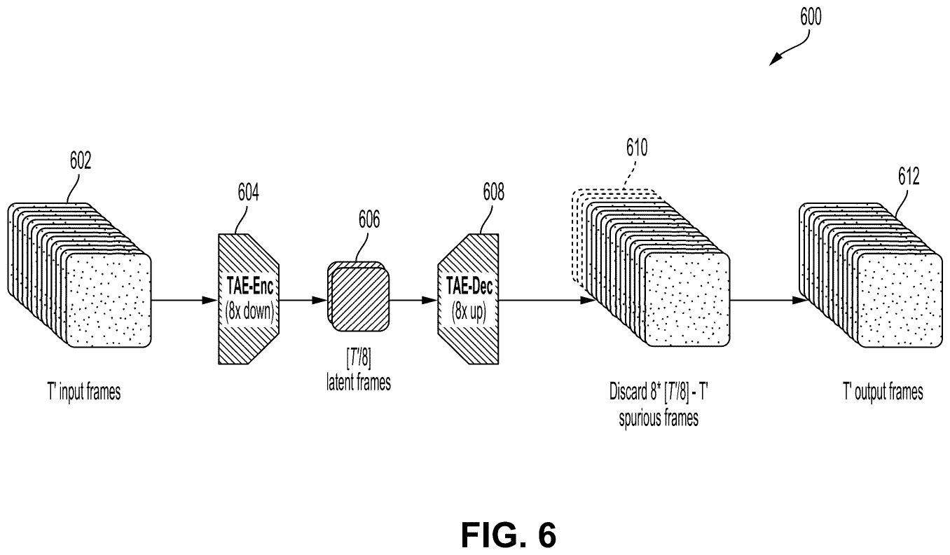

FIG. 6 illustrates an example pipeline 600 for variable-length video encoding and decoding using a temporal autoencoder (TAE), in accordance with various aspects of the present disclosure. The TAE may compress image and video inputs into a spatio-temporally reduced latent space for generative modeling, and to reconstruct pixel-space sequences for output. This approach reduces computational load, enables long and high-resolution video generation, and eliminates the need for separate frame interpolation models.

As shown in FIG. 6, the pipeline 600 receives T′ input frames 602 representing a video sequence of length T′ in the RGB (Red Green Blue) pixel space. The input sequence 602 is processed by a TAE encoder 604 that compresses the input video V of shape T′×3×H′×W′ to a continuous-valued latent representation X of shape T×C×H×W, where T<T′, H<H′, and W<W′. The TAE is based on a variational autoencoder and, in the present implementation, compresses the input by a factor of eight across each spatio-temporal dimension. Accordingly, the ratios satisfy T′/T=H′/H=W′/W=8. This compression reduces the effective sequence length that must be processed by the transformer backbone, significantly improving training and inference efficiency. The encoder 604 outputs approximately ┌T′/8┐ latent frames 606. However, this factor of eight is non-limiting, and other compression ratios may be used depending on desired trade-offs between efficiency and representational fidelity. For instance, compression may occur by a factor greater than or less than eight, and the ratios T′/T, H′/H, and W′/W may be adjusted accordingly. More generally, the compression reduces the effective sequence length that must be processed by the transformer backbone, thereby improving training and inference efficiency regardless of the exact compression ratio selected. As used herein, the shape T′×3×H′×W′ represents a video sequence in the pixel space. The variable T′ represents the number of frames in the input video. The value “3” denotes the three color channels (red, green, and blue) for each frame. The variable H′ represents the pixel height of each frame, and the variable W′ represents the pixel width of each frame.

The TAE encoder 604 architecture may be adapted from 2D image autoencoders and extended with temporal processing layers. Specifically, after each 2D spatial convolution, a 1D temporal convolution is applied, and after each spatial attention block, a 1D temporal attention block is applied. Temporal convolutions use symmetrical replicate padding, and temporal downsampling is performed using strided convolutions with a stride of two. This design enables the encoder to jointly capture spatial appearance and temporal motion information, while reducing the frame rate by a factor of eight. The latent representation X thus includes compressed but semantically rich features describing both spatial layout and temporal dynamics.

The latent frames 606 may be decoded by a TAE decoder 608, which mirrors the encoder architecture and reconstructs sequences in pixel space. The decoder 608 upsamples each of the compressed dimensions—temporal, height, and width—by a factor of eight, producing 8×┌T′/8┐ frames 610. Upsampling may be performed using nearest-neighbor interpolation followed by convolution, which restores frame rate and resolution while preserving consistency with the latent features.

Because the temporal dimension may not always be evenly divisible by the compression factor, the decoding process can yield more frames than the original input sequence length T′. The resulting output 610 thus includes both valid frames and a small number of spurious frames, specifically 8×┌T′/8┐−T′ frames. The pipeline 600 discards these spurious frames 610 so that the final output sequence includes T′ frames 612, preserving fidelity to the input sequence length.

The TAE architecture described in FIG. 6 supports both images and videos. Images are treated as single-frame videos and can be compressed and reconstructed using the same pipeline without modification. By jointly training the TAE on both images and videos, in a ratio such as one batch of images to three batches of videos, the encoder-decoder learns to generalize across modalities while maintaining high-quality reconstructions. Increasing the number of channels C in the latent representation improves both reconstruction accuracy and downstream generation quality. In one implementation, C=16 provides an effective balance between compression efficiency and representational power. By operating in this compressed latent space, the TAE enables the movie gen video model to generate long-form, high-resolution video at native frame rates without reliance on frame-interpolation methods common in prior work. The design simplifies the overall generative framework while improving efficiency and output quality.

In some examples, the systems described herein incorporate improvements to the training objective for the temporal autoencoder to address artifacts observed during reconstruction. Using a standard objective function, decoded pixel-space videos may exhibit undesirable “spot” artifacts. Analysis indicates that these artifacts arise when the model produces latent codes with abnormally high norms at specific spatial locations, referred to herein as “latent dots.” When decoded, these latent dots manifest as localized bright spots in the pixel space. Without mitigation, the model may rely on this behavior as a form of shortcut learning, in which critical global information is stored in isolated latent values rather than being distributed across the latent representation.

Instead of altering the architecture, the systems described herein introduce an outlier penalty loss (OPL) to discourage the model from producing latent values that deviate excessively from the mean distribution. Given an input latent X, the OPL is expressed as:

$${L}_{OPL} ( X , r ) = \frac{1}{H W} {\sum }_{i = 1}^{H} {\sum }_{j = 1}^{W} max ( ‖ {X}_{i , j} - Mean ( X ) ‖ - r \cdot ‖ Std ( X ) ‖ , 0 ) \qquad ( 1 )$$

where H and W represent the spatial dimensions of the latent tensor, and r is a scaling factor that determines how far beyond the standard deviation a latent value must be in order to incur a penalty. For video data, the temporal dimension T is rolled into the batch dimension so that the same formulation applies. An outlier penalty loss (OPL) may be applied to the latent representation to discourage activations that deviate excessively from the mean distribution. The OPL, expressed in Equation 1, measures the deviation of each latent value X_{i,j} from the mean of all latent values and compares the deviation to a threshold defined as a multiple of the standard deviation of the distribution. Latent values that fall within the threshold contribute no penalty, while latent values that exceed the threshold incur a penalty proportional to the excess deviation. The penalties are averaged across the latent spatial dimensions to produce a normalized loss value. This loss term reduces the occurrence of high-norm “latent dots” that otherwise manifest as spot artifacts in decoded videos, thereby improving reconstruction fidelity and stabilizing training.

The OPL encourages the latent distribution to remain within a bounded range around the mean, penalizing outlier activations that would otherwise contribute to spot artifacts. In practice, the systems may set r=3 and apply a loss weight to ensure strong enforcement of the penalty. The OPL may be combined with the standard variational autoencoder losses, including reconstruction loss, discriminator loss, and perceptual loss. Incorporating OPL effectively removes the dot artifacts while preserving reconstruction fidelity.

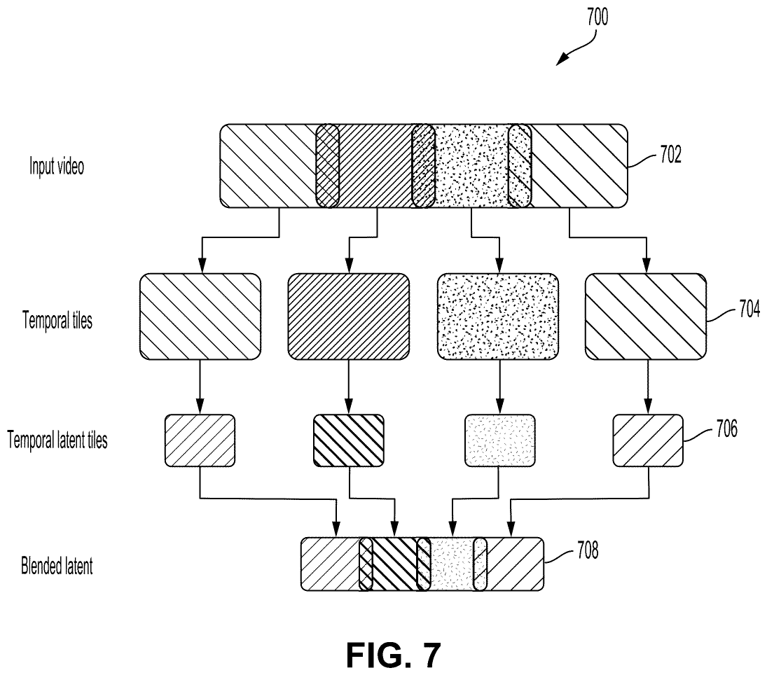

FIG. 7 illustrates an example pipeline 700 for tiled inference using a temporal autoencoder (TAE), in accordance with various aspects of the present disclosure. The pipeline 700 enables efficient encoding and decoding of high-resolution, long-duration videos by dividing the video into smaller temporal segments, or tiles, that may be processed independently and then recombined.

As shown in FIG. 7, an input video 702 of length T′ frames is divided along the temporal dimension into uniform temporal tiles 704. Each tile 704 contains a subset of consecutive frames, and in some examples, adjacent tiles may include an overlap region to facilitate smoother reconstruction. The temporal tiles 704 are independently encoded into corresponding temporal latent tiles 706 by the TAE encoder. Each temporal latent tile 706 represents a compressed spatio-temporal encoding of its respective input tile.

During reconstruction, the temporal latent tiles 706 are decoded and combined to produce a blended latent representation 708. If overlap regions were included between tiles, the overlapping frames are combined using a linear weighted blending procedure. Specifically, for frames i and i+1 within an overlapping region, the blended frame is computed as:

$${x}_{j}^{blend} = {\sum }_{j = 1}^{N} ( {w}_{j} \cdot {x}_{j}^{i} + ( 1 - {w}_{j} ) \cdot {x}_{j}^{i + 1} ) , \qquad ( 2 )$$

where N is the number of overlapping frames, wⱼ=j/N is a blending weight, and

$${x}_{j}^{i} and {x}_{j}^{i + 1}$$

are the corresponding frames from adjacent tiles. The blending weight wⱼ increases linearly across the overlap region, such that the contribution of the earlier tile decreases while the contribution of the later tile increases. This weighted summation produces a blended frame

$${x}_{j}^{blend}$$

that reduces discontinuities and boundary artifacts between tiles, thereby improving temporal coherence in the reconstructed video sequence.

The pipeline 700 allows large video sequences to be processed efficiently without exceeding memory constraints. For example, encoding and decoding a video of resolution 1024×1024 pixels and length 256 frames may not be feasible if processed as a whole. By contrast, tiled inference enables processing of such videos by dividing them into tiles (e.g., 32 raw frames or 4 latent frames per tile) that are processed independently and later stitched together. In practice, tiling may be performed without overlap during encoding and with overlap during decoding, balancing computational efficiency and output smoothness.

The blended latent 708 may be decoded to produce the final output video sequence, which reconstructs the original input video 702 with reduced memory requirements and without boundary artifacts between temporal segments.

In some examples, the systems and methods of the present disclosure employ a Flow Matching framework to train a joint image and video generation model. Flow Matching generates samples from a target data distribution by iteratively transforming a sample drawn from a prior distribution, such as a Gaussian distribution, toward the target. During training, given a video sample in the latent space X₁, a time-step t∈[0,1] and a noise sample X₀˜N(0,1) are selected, and a training sample Xₜ is constructed. The model is trained to predict the velocity

$${V}_{t} = \frac{{dX}_{t}}{dt} ,$$

which represents the instantaneous change needed to move Xₜ in the direction of the target sample X₁.

In some implementations, the training sample Xₜ is constructed using linear interpolation or an optimal-transport path such that:

$${X}_{t} = t {X}_{1} + ( 1 - ( 1 - {σ}_{min} ) t ) {X}_{0} , \qquad ( 3 )$$

where σₘᵢₙ represents a small constant (e.g., 10⁻⁵). The ground truth velocity is then expressed as:

$${V}_{t} = \frac{{dX}_{t}}{dt} = {X}_{1} - ( 1 - {σ}_{min} ) {X}_{0} . \qquad ( 4 )$$

Denoting the model parameters by θ and a text prompt embedding by P, the model predicts the velocity as u(Xₜ, P, t; θ). The training objective minimizes the mean squared error between the ground truth velocity and the model's predicted velocity, expressed as.

$${E}_{t , {X}_{0} , {X}_{1} P} {‖ u ( {X}_{t} , P , t ; θ ) - {V}_{t} ‖}^{2} \qquad ( 5 )$$

In some examples, the time-step t is sampled from a logit-normal distribution with an underlying Gaussian distribution of zero mean and unit variance. This distribution improves coverage of time-steps during training and ensures robust convergence. The interpolation scheme described above further guarantees that the signal-to-noise ratio (SNR) reaches zero when t=0. At this boundary, the training sample Xₜ consists entirely of Gaussian noise, which trains the model to predict velocities from pure noise. This design ensures that, during inference, when the model receives pure noise at t=0, the model produces meaningful predictions that can be iteratively refined into a target image or video.

At inference, the systems generate samples by drawing X₀˜N(0,1) and applying an ordinary differential equation (ODE) solver to integrate

$$\frac{{dX}_{t}}{dt}$$

predicted by the model until reaching X₁. The solver may be configured with various design choices, such as order of accuracy, step size, and tolerance. In some implementations, a first-order Euler solver is used with a discrete set of N time-steps tailored to the model architecture, providing an effective balance between runtime efficiency and precision.

Unlike standard diffusion-based training objectives, which often require hand-designed noise schedules and modifications to achieve a zero terminal SNR, the flow matching framework naturally ensures that the terminal SNR is zero. This property simplifies the training process, improves robustness to noise schedule choices, and enhances performance in video generation tasks. Empirical evaluations indicate that flow matching outperforms diffusion losses in terms of both stability and output quality.

In some examples, the systems described herein perform generation in a learned latent space representation of a video. The latent code may have a shape T×C×H×W, where T denotes the number of latent frames, C denotes the number of latent channels, and H and W denote the spatial height and width, respectively. To prepare the latent code for processing by a transformer backbone, the system patchifies the latent video using a three-dimensional convolutional layer. As referred to herein, Patchify refers to dividing an input video or image into smaller, non-overlapping regions (patches) that can be processed as individual tokens by a transformer model. Instead of treating the entire spatial and temporal dimensions as one continuous array of pixels, the system applies a 3D convolutional layer with a kernel size and stride that segment the latent video tensor into blocks. The three-dimensional convolutional layer applies a kernel of size kₜ×kₕ×k_{w} with a stride equal to the kernel size, and projects the latent code into dimensions compatible with the transformer backbone. The resulting patches are flattened to form a one-dimensional token sequence. The total number of tokens is given by THW/(kₜkₕk_{w}). In some examples, kₜ=1 and kₕ=k_{w}=2, producing 2×2 spatial patches.

In some examples, the system applies factorized learnable positional embeddings to support inputs of arbitrary size, aspect ratio, and temporal length. An absolute embedding of dimension D may be defined as a mapping Φ(i): [0, maxLen]→ [symbol] _{D}, where i represents the absolute index of a patch. The patchified tokens are decomposed into separate positional embeddings Φₕ, Φ_{w}, and Φₜ corresponding to height, width, and temporal coordinates, respectively. Maximum lengths Hₘₐₓ, Wₘₐₓ, and Tₘₐₓ define the upper bounds of the spatial and temporal dimensions for patchified inputs. The final positional embedding may be calculated by summing the factorized embeddings across the spatial and temporal dimensions, and this embedding is added to the input at each transformer layer. Adding positional embeddings to multiple, or all, transformer layers, rather than to only the first layer, has been found to reduce distortion and morphing artifacts, particularly in the temporal dimension.

In some examples, the transformer backbone is based on the transformer block of a large language model(s). The backbone uses normalization and activation functions. For the use case of video generation using flow matching, three modifications are introduced to the baseline block. First, a cross-attention module is added between the self-attention module and the feed-forward network to incorporate text conditioning from a prompt embedding P. Multiple text encoders may be used, and their outputs concatenated into a single embedding sequence to construct P. Second, adaptive layer normalization modules are added to incorporate the training time-step t into the transformer block. Third, the backbone uses full bi-directional attention rather than the causal attention typically employed in language modeling tasks.

The architecture of the backbone is kept simple and closely aligned with large language model (LLM) architectures. This design enables scaling of model size and training using techniques proven effective in LLMs. This architecture performs as well as or better than specialized blocks developed for image or video synthesis, while providing greater training stability across a range of hyperparameters, including model size, learning rate, and batch size.

In some examples, various aspects of the present disclosure use pre-trained text encoders to convert an input text prompt p into a text embedding P, which serves as conditioning input for a video generation backbone. The systems may use a combination of encoders to capture complementary information from the input prompt. The encoders provide both semantic-level and character-level understanding, enabling accurate interpretation of text content and precise alignment with generated visual elements.

In some examples, the encoder is trained on large-scale text-only data and provides strong reasoning ability in its representations. Some encoders may support longer text captions, increasing the length of input text tokens from 77 to 256, thereby improving representation of detailed prompts. Some encoders may be used at the character level to encode visual text, such as explicit character strings specified in the prompt for rendering within the generated output.

In some examples, embeddings from the one or more encoders are processed by separate linear projection layers and normalization layers (e.g., LayerNorm) to align them to a common dimensional space, such as 6144 dimensions. The projected embeddings are concatenated to form a unified embedding P, which conditions the video generation backbone through cross-attention modules.

In some examples, the systems further apply frame-per-second (FPS) conditioning to control the temporal length of generated videos. FPS conditioning is implemented by pre-appending a token to the input text prompt that specifies the sampling FPS value of the corresponding training video (e.g., “FPS-16”). During pre-training, video clips are sampled at their original frame rate, with a minimum of 16 FPS. During finetuning, video clips may be sampled at fixed FPS values, such as 16 and 24, thereby enabling controllable video duration and temporal resolution during inference.

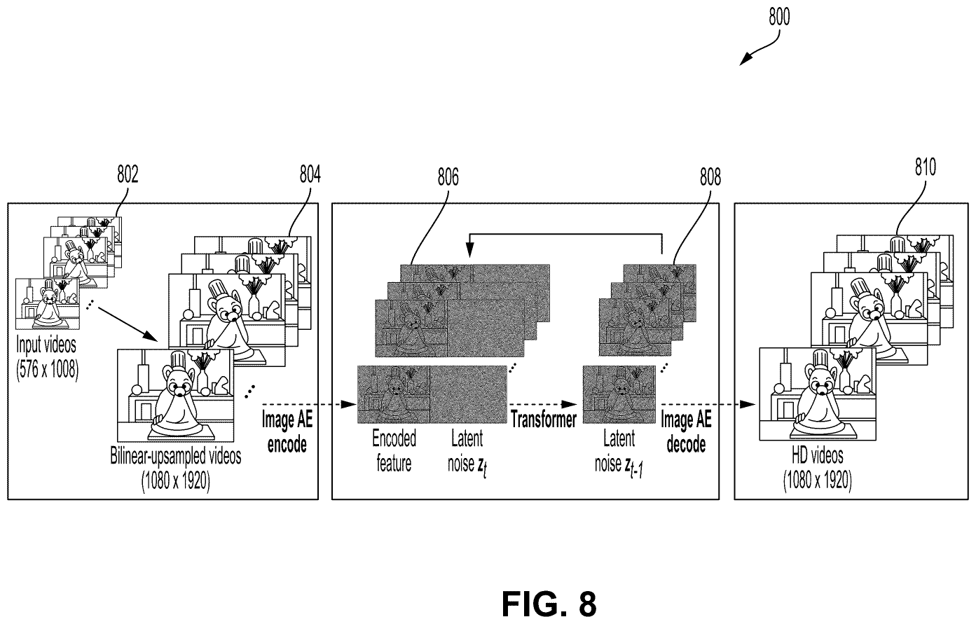

FIG. 8 illustrates an overview of a spatial upsampler pipeline 800, in accordance with various aspects of the present disclosure. The spatial upsampler is a conditional video-to-video model that converts videos generated at a base resolution (e.g., 768 pixels) into full high-definition (HD) videos (e.g., 1080p resolution). By offloading high-resolution processing to a separate upsampler model, the base text-to-video model operates at lower resolution and requires fewer tokens, thereby reducing overall computational cost.

As shown in FIG. 8, the pipeline 800 receives input videos 802. In the example of FIG. 8, the videos 802 have 576×1008 pixels. The input videos 802 are first upsampled in pixel space using bilinear interpolation to yield full-resolution frames (e.g., 1080×1920 pixels). The bilinearly upsampled videos 804 are then encoded frame-wise into a latent representation using an image autoencoder (Image AE). In some examples, a frame-wise variational autoencoder (VAE) encoder is used to improve reconstruction sharpness. The encoded features 806 are concatenated with latent noise zₜ to form the conditional input to a transformer backbone.

The transformer backbone denoises the latent sequence, progressively transforming the latent noise into a coherent HD latent representation 808 that aligns with the upsampled low-resolution video input. This denoising process is performed using a transformer model architecture that is a smaller variant (e.g., 7B parameters) of the text-to-video transformer. The transformer model may be initialized from a text-to-image model trained at 1024-pixel resolution, allowing the transformer model to leverage knowledge from high-quality image datasets.

The HD latent sequence 808 is then decoded using the image autoencoder decoder (Image AE decode) to produce output HD videos 810, for example, at 1080×1920 resolution. The frame-wise decoding produces temporally consistent high-resolution video while preserving sharp spatial details. In some examples, the spatial upsampler is trained on short video clips (e.g., 14 frames at 24 FPS) drawn from a dataset. To increase robustness, the training data is degraded using a second-order degradation process to simulate complex input degradations. In other cases, artifacts produced by the temporal autoencoder (TAE) are substituted to further align training and inference conditions. During training, the encoded low-resolution video features are concatenated channel-wise with the generation input, and the additional channels are zero-initialized to stabilize training.

At inference, the spatial upsampler produces high-quality outputs with relatively few steps (e.g., 20 denoising steps) due to strong conditioning on the low-resolution video input. The upsampler may be applied in a sliding-window manner with a window size (e.g., 14 latent frames and an overlap of 4 frames). To address potential inconsistencies at tile boundaries, the system applies a multi-diffusion technique, in which overlapping frames are blended across denoising steps using weighted averaging of the latents. This optimization ensures temporal consistency across overlapping regions without requiring additional training.

Although the example of FIG. 8 implements 2× spatial super-resolution to produce 1080p output, the spatial upsampler may be extended to other super-resolution factors or resolutions. The design is generalizable to different video resolutions and aspect ratios, enabling scalable and efficient generation of high-quality video content.

In some examples, various aspects of the present disclosure provide infrastructure and architectural strategies that enable scaling and efficient training of a large foundation model for video generation, such as a 30 billion parameter movie gen video model. The training process integrates specialized hardware, distributed training infrastructure, and model-parallelism techniques tailored for high-resolution, long-context video inputs.

In some examples, training is performed using a large number of graphics processing units (GPUs) or other parallel processors, each configured with high-bandwidth memory. The GPUs may be deployed on a server platform that interconnects multiple processors within a server using high-speed switches, and connects processors across servers using high-bandwidth network interfaces. Training jobs may be scheduled and managed using a distributed training scheduler. Such infrastructure provides the bandwidth and throughput necessary to train large-scale media generation models.

In some examples, the training setup differs from state-of-the-art large language models (LLMs) in ways that are specific to video generation. For instance, LLMs commonly employ structured causal attention masks to enforce token causality, which reduces peak memory usage and provides up to a twofold speedup compared to unmasked attention. By contrast, the movie gen video model may use full bi-directional attention across spatial and temporal dimensions, which enables coherent video generation but requires substantially higher computational overhead.

In some examples, LLMs also use grouped-query attention (GQA) in place of multi-head attention (MHA) to reduce the dimensionality of key and value projections. This design lowers the number of floating point operations (FLOPs), decreases tensor memory requirements, and improves bandwidth utilization, while also reducing the size of the key-value cache during inference. The non-autoregressive nature of the movie gen video model does not directly benefit from GQA, and therefore, this optimization is not applied.

Similar to LLM training strategies, the training of the movie gen video model proceeds in stages with varying context lengths. For video training, the effective context length depends on spatial resolution. At 768-pixel resolution, the model processes context lengths on the order of 73,000 tokens, corresponding to a 768×768 pixel video of 256 frames compressed by the temporal autoencoder (TAE) by a factor of 8×8×8, followed by a 2×2×1 patchification. Unlike LLMs, which allocate the majority of training budget to shorter context lengths, the majority of computational resources, such as for example associated with floating point operations (FLOPs), for the movie gen video model are expended on long-context training at 768-pixel resolution.

Due to the quadratic scaling of self-attention operations with respect to sequence length, training at these long context lengths requires substantial computational resources. Accordingly, optimizing infrastructure and training strategies for long-context processing is critical for scaling to high-resolution, temporally extended video generation tasks.

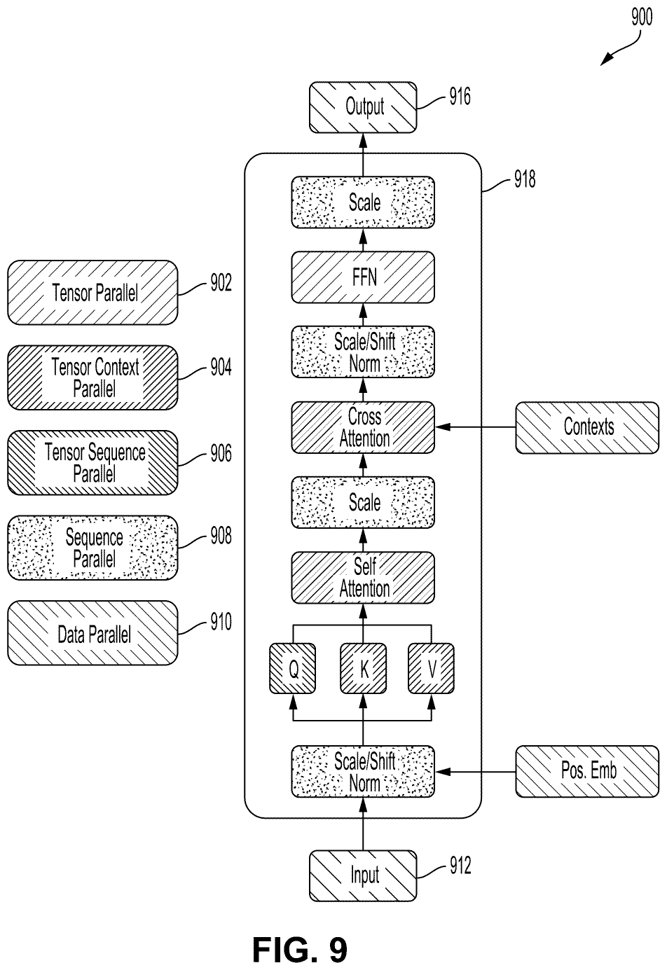

FIG. 9 illustrates an example 900 transformer backbone 918 for a movie gen video model, in accordance with various aspects of the present disclosure. The transformer backbone 918 implements model parallelism strategies that enable efficient training of large-scale foundation models for video generation. The backbone 918 accepts an input 912 that includes positional embeddings and latent tokens representing video data. Through successive layers of scale/shift normalization, self-attention, cross-attention, and feed-forward networks (FFNs), the backbone 918 processes sequences of up to tens of thousands of tokens to produce an output 916 that serves as input for subsequent decoding stages.

The large size of the backbone (e.g., 30 billion parameters) and the long sequence lengths required for high-resolution video generation (e.g., ˜73,000 tokens per sample) make training infeasible on a single device. Accordingly, the system may use multiple parallelism strategies that partition computation across devices along three orthogonal axes: parameters, sequence length, and data samples. This approach, referred to as three-dimensional (3D) parallelism, allows training to scale to thousands of devices while reducing the per-device computational and memory burden.

As shown in FIG. 9, tensor parallelism 902 shards the weights of large linear layers either along rows or columns. Column-parallel sharding reduces the number of activations that must be generated per device, while row-parallel sharding reduces the number of activations that must be consumed per device. These savings come at the cost of requiring collective communication (e.g., all-reduce operations) during the forward and backward passes, but the overall FLOP and activation savings enable substantial scaling.

Tensor context parallelism 904 and tensor sequence parallelism 906 extend these concepts by partitioning along additional axes. Tensor sequence parallelism 906 shards not only the model parameters but also the input sequence, allowing layers such as normalization and activation functions to avoid redundant computation across devices. Tensor context parallelism 904 addresses the self-attention operation, which scales quadratically with sequence length. In self-attention, the dependency lies primarily in the key (K) and value (V) tensors, whereas the query (Q) tensors remain local. By partitioning along the context dimension, only K and V tensors must be communicated between devices, reducing both communication cost and memory overhead.

Sequence parallelism 908 further partitions independent operations across the sequence dimension, such that layers (e.g., LayerNorm) which would otherwise replicate activations, can operate without duplication. This reduces redundant computation and lowers memory usage, which may be desirable when processing very long input sequences.

Fully sharded data parallelism (FSDP) 910 shards model weights, optimizer states, and gradients across all participating devices. This approach reduces per-device memory consumption and ensures synchronous parameter updates. Parameters and gradients are dynamically gathered and scattered during each training step, allowing even extremely large models to be trained efficiently without exceeding device memory.

Within the backbone 918, query, key, and value projections (Q, K, V) for self-attention are distributed across devices according to the selected parallelism strategy. Cross-attention modules accept external context embeddings that may themselves be sharded across devices. Scale/shift normalization layers 914 incorporate both positional embeddings and time-step conditioning, while scaling modules balance activations between major network blocks. The FFNs are themselves partitioned via tensor parallelism to distribute the largest matrix multiplications across multiple devices.

Because parallelism introduces overhead from inter-device communication, the system implements an optimized scheduling framework that overlaps computation with communication. An analytical model predicts communication times, FLOPs, and activation memory usage, identifying duplicated activations and optimizing collective operations such as all-reduce and all-gather. A custom implementation of model parallelism may provide efficient memory scaling, minimizes exposed communication, and enables stable training of models with billions of parameters.

By combining tensor, sequence, and context parallelism with fully sharded data parallelism, the system achieves robust scaling to thousands of GPUs. This parallelism framework allows the movie gen video model to process inputs at high resolution and long temporal contexts, producing coherent video outputs while maintaining feasible training times and hardware utilization.

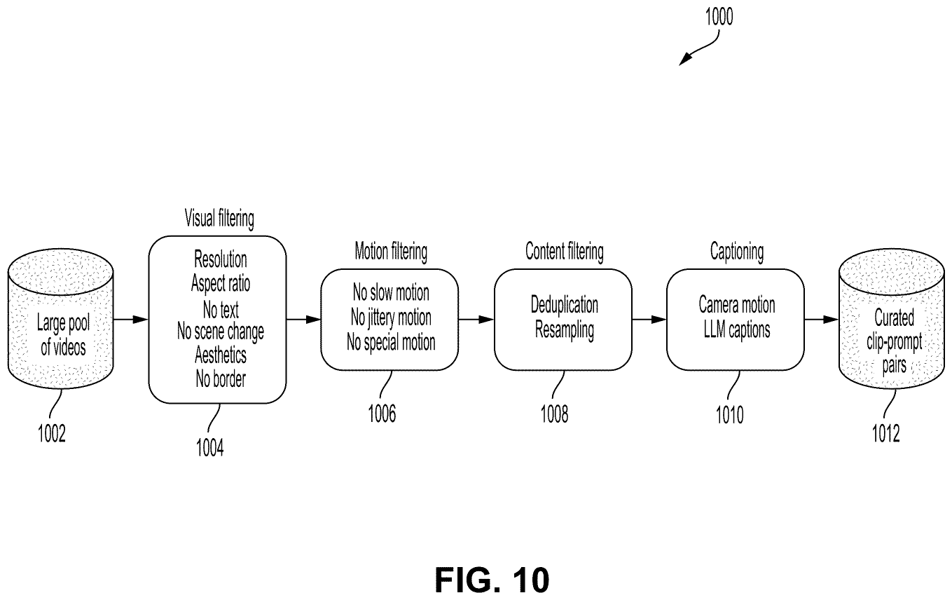

FIG. 10 illustrates an example data curation pipeline 1000 for preparing video training data, in accordance with various aspects of the present disclosure. The pipeline 1000 begins with a large pool of raw videos 1002, which may include videos ranging from approximately four seconds to two minutes in duration and spanning a wide variety of domains such as humans, nature, animals, and objects. This raw pool is subjected to multiple filtering and captioning stages to yield a curated set of high-quality clip-prompt pairs 1012 suitable for pre-training large-scale video generation models.

At a first stage, the visual filtering module 1004 removes videos that do not satisfy predefined visual quality thresholds. For example, videos with resolutions below 720 pixels in width or height may be excluded. Videos are also filtered based on aspect ratio to achieve a target distribution, such as 60% landscape and 40% portrait clips, with a preference for landscape due to its longer duration, better aesthetics, and more stable motion. Further, videos containing excessive embedded text, large borders, or visual effects may be discarded. Scene boundary detection may be applied to extract shorter clips in the range of approximately 4 to 16 seconds. In some examples, visual aesthetic models may be applied to eliminate clips with poor quality or transitional effects, such as unstable motion during the opening seconds of a video.

At a second stage, the motion filtering module 1006 removes clips with inadequate or unstable motion. For example, clips that contain only static frames or slow-motion playback may be discarded. Motion metrics such as, for example, video multi-method assessment fusion (VMAF) scores and motion vectors may be used to evaluate the presence and quality of motion. In addition, the module may identify and remove videos with jittery or unstable camera movement using tools such as shot boundary detection. Special effects, such as slideshow transitions, may also be eliminated.

At a third stage, the content filtering module 1008 reduces redundancy and promotes diversity. Deduplication may be performed by comparing embeddings in a copy-detection space, and resampling may be applied to balance the prevalence of dominant concepts. In some examples, semantic embeddings derived from a video-text joint embedding model may be clustered to identify fine-grained concepts, with duplicate clusters merged. Clips may then be sampled from clusters according to an inverse square root of cluster size to promote diversity across the dataset.

At a fourth stage, the captioning module 1010 generates detailed natural-language descriptions for the filtered clips. Captioning may be performed using large-scale language models, such as fine-tuned video captioning models derived from LLMs. Caption lengths may average approximately 100 words. To further enable cinematic control, a camera motion classifier may predict one of multiple motion categories, such as zoom, pan, or tilt. These predictions may be prefixed to the caption text, allowing explicit conditioning on camera movement during model training and inference. In some examples, a combination of different captioning models (e.g., 8 billion (B) and 70B parameter models) may be used in fixed proportions, such as 70% smaller model captions and 30% larger model captions, to balance efficiency and quality.

The final curated dataset 1012 consists of clip-prompt pairs that meet strict visual, motion, and content diversity requirements. Each pair includes a video clip (e.g., 4 to 16 seconds) and its associated caption with optional camera motion annotations.

In some examples, multi-stage data curation may be employed to generate subsets with progressively stricter filtering criteria. For example, a first subset may include videos with a minimum resolution of 720 pixels for low-resolution training. A second subset may filter for higher resolution, such as a minimum of 768 pixels, to support high-resolution training. A third subset may augment the high-resolution set with additional clips emphasizing specific concepts, such as human-centric content. In one embodiment, the dataset is enriched with videos containing humans by applying zero-shot text-to-video retrieval using a taxonomy of hundreds of human verbs and expressions, ensuring that human-centered clips constitute a significant portion of the training set.

Additionally, bucketization may be used to organize videos by aspect ratio and duration. For example, aspect ratio buckets may include both portrait and landscape orientations, while duration buckets may vary in range, for example, from 4 to 16 seconds. Each bucket ensures that videos within the same group yield latent codes of consistent shape, enabling efficient batching during pre-training. Frame rate tokens may also be appended to captions to provide explicit conditioning for frame rate control during generation.

This curated dataset enables the foundation model to learn meaningful spatiotemporal relationships, such as object motion, subject-object interactions, and camera dynamics, while preserving visual and semantic diversity. By ensuring high-quality and diverse training clips with detailed captions, the model gains the ability to generate coherent long-form videos, maintain consistent characters, perform instruction-based editing, and produce synchronized audio that aligns with visual content.

In some examples, training of the video generation model employs a multi-stage procedure designed to improve training efficiency and scalability when working with models containing tens of billions of parameters. The procedure may include an initial warm-up phase focused on text-to-image (T2I) learning, a joint training phase combining text-to-image and text-to-video (T2V) tasks, and a progression in resolution from lower-resolution data to higher-resolution data. This staged approach enables faster convergence, reduced memory consumption, and improved generalization across modalities.

At the warm-up stage, the model may be trained solely on text-to-image data at a relatively low resolution, such as 256 pixels. Because T2I sequences are significantly shorter than T2V sequences, this stage reduces computational cost and allows the model to ingest a larger volume of training examples within the same compute budget. Initializing from a T2I model also accelerates convergence when transitioning to joint text-to-image-to-video (T2I/V) training compared to training a T2I/V model directly from scratch.

Following the warm-up stage, the model undergoes joint training for T2I and T2V tasks. For this stage, modifications to the architecture may include expansion of positional embedding layers to accommodate variable aspect ratios and additional temporal embeddings to represent multiple latent frames. For example, the system may extend spatial embeddings by factors of 2× or 3× to align with higher-resolution training (e.g., from 256 pixels to 768 pixels). Temporal embeddings may be added to support clips containing up to 32 latent frames. During this phase, the model may be trained with large batch sizes, such as over one thousand samples per iteration, and the learning rate may be tuned dynamically to stabilize training as context lengths increase.

Resolution scaling further improves performance. At a first resolution stage (e.g., 256 pixels), training may proceed for hundreds of millions of video samples, with subsequent scaling to 768 pixels for later stages. Validation loss curves may be monitored throughout, and adjustments such as halving the learning rate when the loss plateaus may be employed to maintain improvements in convergence and output quality.

In addition to pre-training, supervised finetuning (SFT) is employed to enhance the model's ability to generate cinematic-quality video. Finetuning data may be selected using a combination of automated filtering and manual curation. Automated filters may enforce thresholds on aesthetics, scene changes, motion quality, and subject detection. Candidate pools may then be balanced across semantic concepts using k-nearest neighbor retrieval against a taxonomy of human verbs and expressions, yielding subsets that can be manually evaluated. Human annotators may further refine the selection by enforcing constraints on lighting, color balance, motion naturalness, and the absence of clutter or artifacts. Annotators may also trim raw videos into 10-16 second clips and manually refine captions to ensure inclusion of detailed camera motion, subject actions, and environmental conditions.

During supervised finetuning, the model may be trained using smaller batch sizes and reduced compute resources compared to pre-training. For example, the finetuning process may use a few hundred GPUs across multiple nodes, along with learning rate schedulers such as cosine annealing. Training may occur at frame rates of 16 or 24 FPS, depending on the duration of the clip, enabling the model to generalize across both short and long-form temporal contexts.

To improve robustness and performance, multiple models trained on different finetune subsets and hyperparameter settings may be combined using model averaging. This approach leverages complementary strengths of the individual models, improving qualities such as motion fidelity, temporal consistency, and controllability of camera parameters. The resulting averaged model exhibits more stable and reliable generation behavior than any individual model trained in isolation.

In some examples, sampling from the video generation model may be performed using specific hyperparameters and inference techniques that improve both efficiency and output quality. In one implementation, a classifier-free guidance scale of approximately 7.5 is used for text conditioning, and sampling may be performed with a linear-quadratic schedule that achieves quality comparable to a substantially larger number of linear steps.

To further improve prompt alignment, an inference prompt rewrite model may be employed. Training captions used for pre-training are typically long and detailed, often averaging more than one hundred words, whereas inference prompts provided by end users are typically short, often fewer than ten words. To bridge this gap, the system may automatically expand and restructure user prompts into longer and more detailed descriptions. In some examples, a large language model may be trained to perform prompt rewriting based on examples from the pre-training dataset. The rewritten prompts may follow a standardized information structure, simplify complex vocabulary into more accessible terminology, and avoid excessive detail that may otherwise introduce artifacts into the generated video.

In some implementations, a teacher-student distillation approach is employed to improve efficiency of the inference rewrite model. A teacher model, such as a large-scale LLM-based model, may first generate high-quality rewrites for a large pool of prompts. Human-in-the-loop filtering may then be applied to select the best examples, and these examples may be used to finetune a smaller student model, such as an 8B parameter model. The distilled model provides high-quality rewrites with substantially lower computational overhead, reducing latency during inference.

For efficient video sampling, the system may use an Euler sampler with a customized schedule. Empirically, the Euler sampler has been observed to outperform higher-order solvers, such as midpoint or adaptive methods, for this application. Reducing the number of inference steps for video generation is particularly challenging due to the temporal dimension: motion quality and alignment with text prompts are more sensitive to step count than for still images. For example, videos generated with 250, 500, or 1000 linear steps may differ noticeably in composition and motion fidelity.

To address this, the system may approximate an N-step generation process using far fewer steps. In one implementation, a linear-quadratic schedule is applied, whereby the first portion of the steps (for example, the first 25 of a 1000-step linear schedule) is performed linearly, and the remaining steps are approximated with quadratically spaced steps. The linear steps establish the basic scene structure and motion dynamics, while the quadratic placement of later steps emphasizes refinement without requiring the full number of iterations. This approach allows a process that would otherwise require hundreds or thousands of steps to be approximated in as few as 50 steps, achieving up to a 20× improvement in efficiency with minimal quality degradation.

This inference configuration, combining classifier-free guidance, prompt rewriting, and linear-quadratic sampling, allows the system to generate coherent and high-fidelity videos in significantly less time and with reduced computational resources, while maintaining strong alignment with user-provided text prompts.

In some examples, various aspects of the present disclosure may further include an evaluation module configured to assess the quality of generated media. The evaluation module may operate along multiple axes that are particularly relevant to text-to-video generation, such as alignment with the input text prompt, visual quality across individual frames, and overall realness or aesthetic appeal. By incorporating such evaluation criteria, the system can provide feedback to guide model development or fine-tuning, and ensure that generated outputs maintain temporal consistency, photorealistic quality, and faithful adherence to user instructions. These evaluation processes highlight technical improvements of the disclosed system over prior approaches, which often fail to maintain prompt alignment or temporal coherence across extended video sequences.

In some examples, various aspects of the present disclosure may extend to image generation in addition to video generation. Because the model is trained jointly on image-text pairs and video-text pairs, it can generate both still images and video sequences. To further enhance image generation performance, the system may employ an image autoencoder in place of the temporal autoencoder. In such embodiments, the model may be trained on a text-to-image generation task using curated image-text data, thereby enabling the generation of high-resolution images based on natural-language descriptions.

In one implementation, the system may generate images at resolutions of up to 1024 pixels. However, this resolution is non-limiting, and the model may be configured to generate images at lower or higher resolutions depending on available training data, computational resources, and application requirements. A curated set of training images, for example, on the order of thousands of high-quality images created by professional artists, may be used for supervised post-training or quality tuning. Training may be performed for a fixed number of iterations, such as several thousand steps, using a learning rate in the range of 10⁻⁵ to 10⁻⁶ and moderate batch sizes, such as 64 samples per batch. In some examples, a constant learning rate schedule with a warm-up phase may be employed to stabilize convergence. This post-training procedure improves image fidelity and alignment with text prompts, and allows the same foundation model to deliver state-of-the-art results for both text-to-image and text-to-video generation tasks.

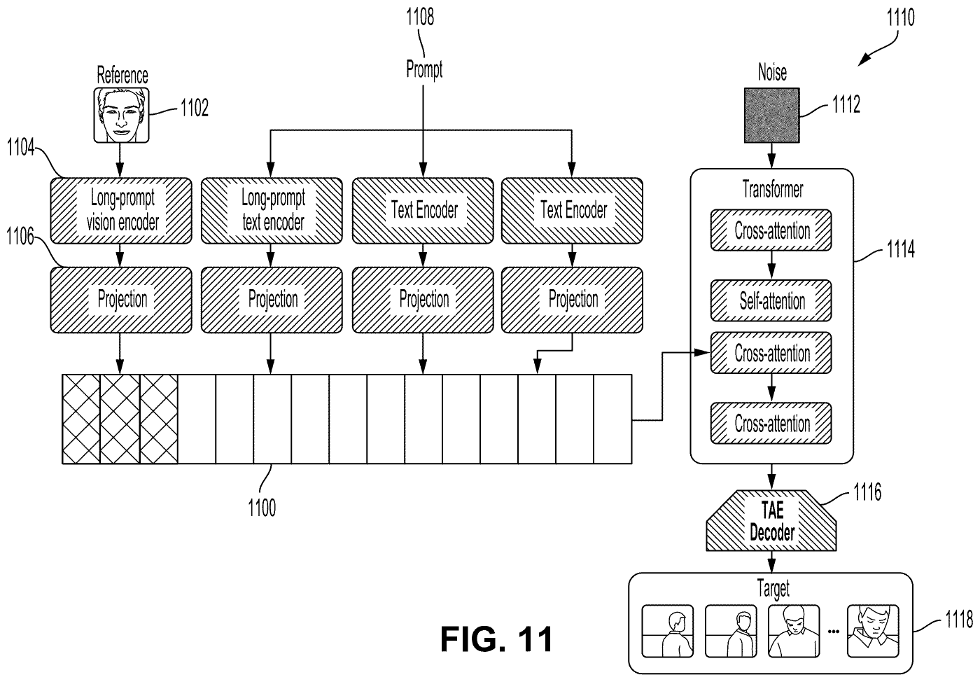

FIG. 11 illustrates an example architecture and inference pipeline 1110 for a personalized text-to-video (PT2V) model, in accordance with various aspects of the present disclosure. The pipeline 1110 extends a foundation text-to-video model to include conditioning on a reference image 1102 in addition to a text prompt 1108, enabling generation of personalized video sequences that preserve the identity of the depicted individual.

As shown in FIG. 11, a reference image 1102 may be processed by a vision encoder 1104, such as a trainable encoder initialized from a long-prompt visual-text model. The output of the vision encoder 1104 is projected by a projection layer 1106 into the same feature space as text embeddings. The system concatenates the projected vision features with embeddings derived from multiple text encoders applied to the input prompt 1108. In some examples, these text encoders may include, but are not limited to different models, such as a mixture-of-denoisers (MoD) based LLM(s), a raw text bytes based LLM(s), and long-prompt contrastive language-image based LLM text. Each encoder is followed by a projection layer to align dimensions, and the concatenated sequence of embeddings 1110 serves as conditioning input.

During inference, Gaussian noise 1112 is provided to a transformer backbone 1114, which applies a sequence of attention operations, including cross-attention, self-attention, and normalization layers, conditioned on the concatenated embeddings. The output of the transformer 1114 is decoded using a temporal autoencoder (TAE) decoder 1116 to produce the final video frames 1118. The generated video preserves the identity features captured from the reference image while following the semantic content of the text prompt.

In some examples, the model may be trained in multiple stages, including pre-training and fine-tuning phases. During pre-training, the system may focus on videos where the same individual appears across all frames. Training data may be curated by filtering raw video-text pairs to retain only clips with single faces, where consecutive frames satisfy a similarity threshold based on an identity-matching metric, such as for example ArcFace. This produces a dataset containing millions of samples of humans in short clips (e.g., 4-16 seconds).

Two categories of training data may be used. In paired data, the reference image is taken from the same video clip as the target, with sampled face crops segmented to emphasize the face region. In cross-paired data, the reference image originates from a different video of the same subject. Cross-paired data prevents the model from learning trivial solutions such as replicating the expression or pose of the reference frame, instead enforcing generalization of identity features.

Cross-paired data may include both real and synthetic examples. Real cross-paired data may be sourced from videos containing multiple views of the same person. Synthetic cross-paired data may be generated using a personalization image generation model to create novel reference images from a base frame, varying properties such as facial expression, head pose, or lighting. Generated synthetic reference images may be filtered based on similarity thresholds to ensure identity consistency.

Through this architecture and training strategy, the personalized text-to-video (PT2V) model produces personalized videos that not only follow the input text prompt but also maintain the identity of a reference subject across frames and scenes. This approach supports practical applications such as creating personalized avatars, film production, and custom media generation while overcoming limitations of prior models that lacked consistent identity preservation.

In some examples, pre-training of the PT2V model may proceed in multiple stages to achieve three primary objectives: condition the model on a reference image and preserve the identity of the depicted subject, enable the generation of long personalized video sequences, and improve the naturalness of human expressions and motion in the generated video.

Training a personalized video generation model directly on long video clips can be inefficient, as the computational cost of training increases approximately with the square of the number of latent frames. In addition, weak correspondence between a single reference image and the content of long video clips complicates identity preservation. Accordingly, the PT2V model may be pre-trained in stages, as described below.

At an initial stage, the PT2V model is trained to rapidly learn identity preservation using paired data samples. A reference image is provided as conditioning input, and the model is trained on relatively short video clips to simplify the identity injection task. For example, temporal autoencoder (TAE) embeddings may be truncated to a small number of latent frames (e.g., 8 latent frames corresponding to approximately 64 RGB frames). In some implementations, the vision encoder may be frozen while training the transformer backbone. This allows the model to quickly learn to follow the reference image and generate video frames that capture consistent identity features, as may be measured by similarity scores such as, for example, ArcFace.

In a subsequent stage, the PT2V model is extended to handle longer video clips. Starting from the weights obtained in Stage I, the model is trained with a larger number of latent frames, similar to those used in a general-purpose text-to-video pre-training pipeline. This stage improves the model's ability to generate longer personalized videos while maintaining background consistency, motion coherence, and temporal stability across frames.

To further improve the realism of facial expressions and naturalness of human motion, the model is trained with cross-paired samples, where the reference image is not extracted from the same video as the target frames. Training solely on paired data can lead to a “copy-paste” effect, where the generated subject rigidly mimics the pose or expression of the reference image. By including cross-paired data, both real and synthetically generated, the model learns to generalize identity preservation while allowing for varied poses, expressions, and lighting. At this stage, the vision encoder may also be finetuned to extract more detailed identity features from the reference image.

Through this multi-stage pre-training process, the PT2V model develops the capability to generate long, personalized videos that preserve subject identity while producing natural expressions and motion, thereby addressing limitations of prior approaches that exhibited reduced identity consistency or unnatural appearance in generated content.

In some examples, the PT2V model may undergo a supervised finetuning stage to further enhance the visual aesthetics, motion quality, and overall realism of the generated videos. This finetuning stage operates on a smaller, curated dataset of high-quality samples, selected to match or exceed the visual standards established for the general text-to-video model.

The finetuning dataset may be constructed by starting from a pre-existing set of curated video clips used for text-to-video post-training, and filtering that set to retain only clips containing a single person. From this subset, additional manual selection may be applied to ensure that the data includes a diverse range of human actions, gestures, and expressions, thereby covering multiple modes of human behavior. The resulting dataset may include both paired samples (where the reference image is taken from the same video as the training clip) and real cross-paired samples (where the reference image originates from a different video of the same subject). In one embodiment, paired and cross-paired data may be used in a balanced proportion, such as a 1:1 ratio.

In some implementations, the finetuning dataset may contain on the order of one thousand high-quality video clips, each annotated with corresponding captions or prompts. The dataset may also undergo additional filtering steps to ensure that the selected clips exhibit properties such as stable camera motion, clear lighting, high aesthetic quality, and natural subject behavior. By applying this supervised finetuning stage, the PT2V model achieves improved video generation quality, with outputs that preserve subject identity while presenting cinematic-level motion and aesthetics.

In some examples, various aspects of the present disclosure include text-guided video editing, wherein a user may provide a source video and a natural language instruction to produce a modified video. Text-guided video editing addresses limitations of conventional editing tools, which may be inaccessible to non-experts and time-consuming for skilled users. By contrast, conditioning a generative video model on both an input video and an editing instruction enables intuitive, fast, and precise edits controlled entirely through natural language.

Developing high-quality video editing models presents unique challenges due to the scarcity of supervised video editing datasets. Unlike text-to-video generation, where large-scale paired data can be collected, supervised editing data is far less practical to obtain at scale. Accordingly, various aspects of the present disclosure introduce a staged training process that reduces discrepancies between training conditions and test-time editing conditions, thereby enabling high-quality editing performance without supervised editing data.

The training approach is guided by two key design assumptions. First, explicitly training the model for video editing tasks provides greater capability and controllability compared to training-free approaches, and requires processing the full video input rather than proxy features such as depth maps or segmentation masks. Second, minimizing discrepancies between training and inference conditions is essential, as reliance on mismatched training data leads to artifacts and reduced editing quality.

In a first training stage, a foundation text-to-video model is trained with a multi-tasking objective that alternates between image editing and video generation. Image editing is treated as single-frame video editing, providing a means to bootstrap editing capability while maintaining the ability to generate new videos from prompts. After this stage, the model demonstrates some ability to generalize to multi-frame video editing but often produces blurry outputs, reflecting the distribution shift between single-frame training and multi-frame inference.

In a second stage, two new synthetic tasks are introduced to better align training with multi-frame editing scenarios. In one synthetic task, examples of image editing are animated into short video sequences using random affine transformations, thereby simulating frame-to-frame consistency. In a second synthetic task, video segmentation is reframed as an editing problem, requiring the model to modify or highlight a specific object in a video using a prescribed instruction, such as coloring the object with a specific color. These tasks encourage the model to develop temporal consistency across frames and improve its capacity to follow edit instructions. After this stage, artifacts such as oversaturated regions and unnatural motion may still appear, particularly when newly generated elements are introduced.

In a third stage, the system introduces a backtranslation-style training process adapted for video editing. In one example, the model applies a synthetic editing instruction to a video and is then tasked with reconstructing the original unedited video. This approach exposes the model to high-quality edited sequences during training and reduces the discrepancy between training and inference. The result is a substantial improvement in motion naturalness and reduced oversaturation, yielding more realistic editing outcomes.

This staged approach produces a text-guided video editing model, also referred to as movie gen edit, which supports edits across a wide variety of input formats, including videos of varied aspect ratios, resolutions, and frame rates. Unlike prior models limited to short, square, or low-resolution clips, the disclosed system can edit longer and higher-quality videos while preserving photorealistic fidelity and motion coherence.

In some examples, system performance may be evaluated using a comprehensive benchmark dataset specifically designed for video editing. This benchmark, referred to as movie gen edit bench, includes six editing tasks with diverse instructions and corresponding videos. Unlike prior benchmarks that assume short, low-resolution clips, this benchmark spans multiple durations, aspect ratios, frame rates, and resolutions, thereby reflecting real-world video editing conditions. Human evaluation studies indicate that generated edits from the disclosed system are preferred to outputs from prior state-of-the-art approaches in the majority of cases, confirming the technical advantages of the disclosed methods.

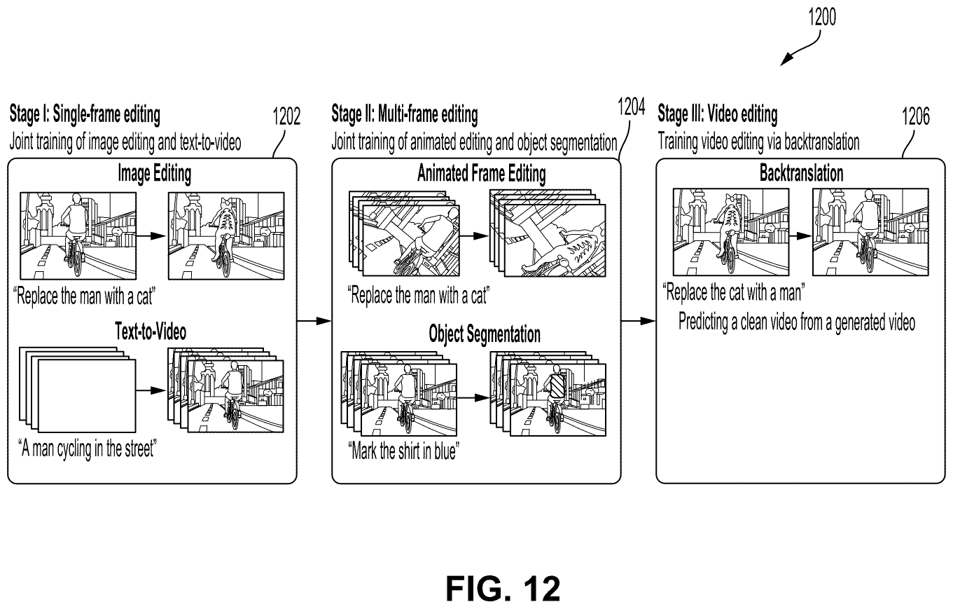

FIG. 12 illustrates an example training pipeline 1200 for a text-guided video editing model, in accordance with various aspects of the present disclosure. The pipeline 1200 reduces discrepancies between training and inference by progressively introducing editing tasks of increasing complexity across three stages: single-frame editing 1202, multi-frame editing 1204, and video editing with backtranslation 1206.

At the first stage 1202, the system trains the model jointly on text-to-image editing tasks and text-to-video generation tasks. In one example, the image editing task may involve modifying a single frame based on a textual instruction, such as “replace the man with a cat.” Treating image editing as single-frame video editing allows the model to learn an initial ability to follow textual editing commands. At this stage, the model may also be trained to generate short video clips directly from text prompts, such as “a man cycling in the street.” While this stage provides baseline editing capability, inference on multi-frame sequences often yields blurry or inconsistent outputs due to a mismatch between single-frame training and multi-frame evaluation.

At the second stage 1204, the system introduces multi-frame synthetic editing tasks to narrow the train-test gap. In one example, animated frame editing may be performed by applying random affine transformations to single-frame editing results, thereby producing short video clips with simulated temporal continuity. For instance, an instruction such as “replace the man with a cat” may be extended across multiple frames. In another example, object segmentation may be reformulated as a video editing task, where the model receives an instruction such as “mark the shirt in blue” and is trained to modify or highlight the specified object consistently across frames. These synthetic tasks improve temporal consistency and editing precision while teaching the model to process full video inputs.

At the third stage 1206, the system applies a backtranslation-based training strategy for video editing. In this stage, the model may apply an editing instruction to generate a modified video (e.g., “replace the cat with a man”), and then be tasked with reconstructing the original unedited video. This round-trip objective exposes the model to high-quality edited sequences during training and minimizes the discrepancy between synthetic training data and real-world editing scenarios. The backtranslation strategy reduces artifacts such as oversaturation and improves the naturalness of motion and expressions in the edited outputs.

Through this staged training process, the system learns to perform high-quality, text-guided video editing without requiring large-scale supervised editing datasets. The model achieves improved temporal coherence, natural motion, and photorealistic fidelity while supporting edits across diverse video formats, including multiple aspect ratios, frame rates, and resolutions.

To support video editing, the model architecture incorporates several modifications relative to the text-to-video design described previously. In one aspect, the system enables conditioning on an input video by expanding the patch embedding layer with additional input channels. This allows the latent representation of an input video to be concatenated with the noisy latent representation of the output video along the channel dimension. The concatenated representation is then provided to the model backbone, enabling the model to leverage both the source video content and the generation process during training and inference.

In another aspect, the system incorporates conditioning on specific editing tasks. In some examples, a learned task embedding is maintained for each supported operation, such as object insertion, object removal, background modification, or style adjustment. For a given editing task, the corresponding task embedding is passed through a first linear transformation to produce four vectors that are concatenated with hidden states output by the text encoders. The task embedding is also processed by a second linear transformation, the output of which is added to the temporal step embedding. This approach enables the model to distinguish and adapt its behavior for different types of edits. To preserve the fidelity of the base video generation model, all newly introduced weights are initialized to zero, while the original model weights are initialized from a pre-trained text-to-video checkpoint.

Formally, the editing architecture conditions on a triplet c=(TAE(c_{vid}), c_{instruct},j), where c_{vid} represents the input video, TAE represents the temporal auto-encoder, c_{instruct} represents the textual editing instruction, and j specifies the identifier of the editing task. During training, the flow step is updated as u(Xₜ, c, t; θ), where Xₜ are the latents of the output video x_{vid} at flow step t, and θ are the model parameters.

In the first stage of training, the model is adapted to use both an input video condition and an editing instruction during denoising of the output video. Due to the scarcity of supervised video editing datasets, the model leverages image editing datasets by treating images as single-frame videos. Each training sample consists of triplets C_{image-edit}=(C_{img}, C_{instruct}, x_{img}), where c_{img} represents the input image, c_{instruct} represents the editing instruction, and x_{img} represents the edited output image. To maintain temporal consistency, the model is simultaneously trained on both image editing tasks and text-to-video generation tasks. For the latter, the model is conditioned on a black placeholder video to represent the absence of an input video, resulting in training triplets c_{text-to-video}=(c_{θ}, c_{instruct}, x_{vid}), where c_{θ} is a black video and c_{instruct} represents the rephrased caption instruction. Training alternates between image editing and video generation batches, with image editing sampled more frequently (e.g., at a 5:1 ratio), to accelerate convergence while preserving the model's video generation capabilities.

The training objective is defined as E_{t,x}_{₀}_{,x}_{₁}_{,c}∥u(Xₜ, c, t; θ)−Vₜ∥², where c is drawn from a categorical distribution over text-to-video samples and image-editing samples with weights ⅙ and ⅚, respectively. To avoid positional embedding collapse during image editing, a randomly sampled temporal positional embedding is used rather than the first frame's positional embedding.

While the first stage model demonstrates strong image editing performance and retains video generation capabilities, its outputs for video editing are blurry and temporally inconsistent. These artifacts stem from a discrepancy between the first stage of training (single-frame conditioning) and the multi-frame conditioning specified during inference. To reduce this train-test discrepancy, two complementary synthetic datasets are introduced.

In some examples, a function may be used for generating an animated frame editing dataset, which provides temporally consistent multi-frame training examples for text-guided video editing. The function begins with a video-caption dataset (cₜₓₜ, x_{vid}), where cₜₓₜ denotes the caption describing the video content, and x_{vid} denotes the corresponding video. An editing model p_{θ} is used in conjunction with this dataset. The objective of the algorithm is to generate animated input frame sequences ĉ_{vid}, corresponding animated edited frame sequences \hat{x}_{vid}, and the editing instruction c_{instruct}

First, the system prompts a large language model, with the input caption cₜₓₜ to automatically generate an editing instruction c_{instruct} (e.g., “replace the man with a cat”) and optionally an updated caption ĉₜₓₜ describing the target edit (e.g., “a cat walking down the street”). Next, a random frame x_{frame} is sampled from the video x_{vid}, and the editing model p_{θ} is applied to this sampled frame together with the instruction c_{instruct}, yielding an edited frame x_{frame}. At this stage, the function initializes two sequences: the animated input sequence ĉ_{vid} and the animated edited sequence \hat{x}_{vid}, both initially empty. These sequences are seeded with the sampled input frame x_{frame} and its corresponding edited frame \hat{x}_{frame}.

The function then enters an iterative process of length n, where each iteration introduces temporal variation by applying random affine transformations. For iteration i, a random affine augmentation [symbol] is sampled, which may include transformations such as scaling, rotation, translation, or shearing. The augmentation [symbol] is applied both to the input frame from the prior iteration

$${x}_{frame}^{( i - 1 )}$$

and to the edited frame from the prior iteration

$${\hat{x}}_{frame}^{( i - 1 )} ,$$

producing new input and edited frames

$${x}_{frame}^{( i )} and {\hat{x}}_{frame}^{( i )} ,$$

respectively. These new frames are appended to their respective animated sequences, thereby extending both the input and edited frame sequences with temporally consistent updates.

After completing all n iterations, the algorithm outputs the animated input sequence ĉ_{vid}, the editing instruction c_{instruct}, and the animated edited sequence \hat{x}_{vid}. The resulting dataset examples c_{animated}=(ĉ_{vid}, ĉ_{instruct}, \hat{x}_{vid}) provide the model with synthetic multi-frame training pairs that preserve temporal continuity between original and edited content. This process enables the construction of large-scale multi-frame editing datasets without requiring explicit supervised video editing data. By leveraging language-model-generated instructions, single-frame edits, and affine transformations to simulate temporal dynamics, the algorithm creates realistic training examples that help bridge the gap between image editing and video editing.

A video segmentation task may be framed as a video editing task by instructing the model to highlight or modify a particular object consistently across frames. For example, the model may receive an instruction such as “mark the shirt in blue” and be trained to apply the modification throughout the clip. By training on both animated frame editing and segmentation-as-editing tasks, the model learns to process multi-frame video inputs and produces more temporally coherent and visually natural edited outputs.

In some implementations, the training pipeline supplements animated frame editing examples with a generative instruction-guided video segmentation task. This task mitigates the lack of natural motion in animated frame editing by extending segmentation-based editing from static images to dynamic video sequences. In particular, the model is trained to modify an input video by marking a designated object in a specified color in accordance with a text instruction. To construct such training data, a large language model generates an editing instruction, denoted c_{instruct}, that specifies both the target object and the intended color (for example, “mark the apple in red”). The language model also outputs the object identifier to maintain semantic consistency across samples. A segmentation mask for the identified object is then extracted from the input video c_{vid} using vision models, which provide frame-level object boundaries. The mask is applied across frames to create a corresponding target video \hat{x}_{vid}, in which the designated object is consistently highlighted with the instructed color. The resulting paired data sample may be expressed as c_{segmentation}=(c_{vid}, c_{instruct}, \hat{x}_{vid}), where c_{vid} represents the real input video, c_{instruct} represents the instruction prompt, and \hat{x}_{vid} represents the edited video with the highlighted object. By combining the input video, the instruction prompt, and the segmentation-based target output, this task provides the model with multi-frame editing examples that explicitly link textual instructions with temporally coherent visual modifications. Such training data enables the model to learn both semantic understanding of natural language instructions and consistent temporal editing across video frames, thereby reducing train-test discrepancies and improving the naturalness of generated video edits.

In some examples, the model trained during the first stage may be further finetuned using a multi-task training procedure that integrates animated frame editing, instruction-guided video segmentation, and text-to-video generation. This finetuning stage is executed for approximately one thousand steps, with the training objective designed to balance between tasks while prioritizing animated frame editing examples. Specifically, training batches are sampled such that animated frame editing examples are drawn with three times the frequency of instruction-guided video segmentation and text-to-video examples. Formally, the sampling distribution can be expressed as: c˜Categorical({c_{text-to-video}: ⅕, c_{animated}: ⅗, c_{segmentation}: ⅕).

This multi-task objective (e.g., second stage) allows the model to leverage complementary strengths from each dataset: animated frame editing contributes detailed temporal editing supervision, segmentation provides semantically precise object-level control, and text-to-video generation ensures that the model maintains general video synthesis capability. Empirically, this training stage mitigates the blurriness artifacts observed in the first stage outputs. However, qualitative evaluation indicates that newly generated elements within edited videos may exhibit reduced motion fidelity and occasional oversaturation, suggesting that further refinements are needed to improve naturalness and balance motion realism with visual consistency.

The third stage addresses the remaining artifacts from earlier stages of training, namely the lack of natural motion in newly generated elements and the tendency of those elements to appear oversaturated. These issues arise because the animated frame editing examples used in prior stages rely heavily on synthetic, model-generated outputs that lack the diversity and realism of true video motion. To overcome this limitation, the third stage introduces a backtranslation strategy that leverages real output videos as supervisory signals.

In this stage, the process begins with a dataset of real videos x_{vid} paired with captions cₜₓₜ (for example, “Apples on a table”). A large language model, such as LLaMa3, is then used to generate an editing instruction c_{instruct} (for example, “Put the apples in a small basket”) and a corresponding updated caption cₜₓₜ (for example, “Apples in a small basket on the table”). Using the second stage editing model p_{θ}, an edited video\hat{x}_{vid}˜pθ(x_{vid}, c_{instruct}) is generated based on the input video and the editing instruction. The resulting dataset (cₜₓₜ, ĉₜₓₜ, x_{vid}, \hat{x}_{vid}) is filtered using automated metrics, such as, for example, a video-language AI model based on a contrastive language-image LLM, scores to ensure quality and alignment, in a manner similar to the filtering used in the second stage.

A direct approach would be to finetune the model on pairs of the form (x_{vid}, c_{instruct}, \hat{x}_{vid}), effectively teaching the model to reproduce its own outputs. However, such an approach risks reinforcing the very artifacts, oversaturation and unnatural motion. To address this, the third stage adapts the backtranslation technique, originally developed in natural language processing, to the domain of video editing. Specifically, the framework uses the triplet (cₜₓₜ, ĉₜₓₜ, c_{instruct}) to prompt the language model to generate a new backward editing instruction c_{instruct-bwd}, which specifies how to transform the edited video \hat{x}_{vid} back into the original unedited video x_{vid} (for example, “Remove the small basket and put the apples on the table”). This creates a synthetic paired dataset c_{backtranslation}=(\hat{x}_{vid}, c_{instruct-bwd},x_{vid}).

By training the model on this backtranslation dataset, the system learns to denoise and refine edited outputs by conditioning on both the potentially noisy generated video and the backward editing instruction, with the target being the clean original video. This approach reduces the train-test discrepancy, injects natural motion, and mitigates oversaturation, ultimately leading to higher quality and more realistic video editing outcomes.

The disclosed audio generation system, referred to as movie gen audio, is designed to generate complete soundtracks for video clips, short films, or similar media content. The soundtracks may span durations from only a few seconds to several minutes. In the present work, the soundtrack encompasses ambient background sounds, Foley sound effects, and instrumental music. Speech and music containing vocals are excluded to focus the system on cinematic-style audio.

Recent advances in generative modeling have enabled high-quality video synthesis; however, producing an accompanying soundtrack that matches the generated visuals remains a critical challenge. A complete cinematic experience requires more than just imagery—sound is essential for immersion, mood, and narrative coherence. Traditional methods for soundtrack creation rely on manual sound design, Foley recording, or post-production editing, which are time-consuming and demand significant expertise. Accordingly, there is a need for automated systems that can generate synchronized, high-fidelity soundtracks directly from video inputs and natural-language prompts.

The disclosed audio generation system, referred to as movie gen audio, is designed to generate complete soundtracks for video clips, short films, or similar media content. The soundtracks may span durations from only a few seconds to several minutes. In the present work, the soundtrack encompasses ambient background sounds, Foley sound effects, and instrumental music. Speech and music containing vocals are excluded to focus the system on cinematic-style audio.

In operation, the system ensures that ambient sound is consistent with the depicted visual environment, that sound effects are temporally synchronized with on-screen actions and physically plausible for the corresponding visual objects, and that instrumental music conveys the mood and sentiment of the video while blending seamlessly with the ambient and Foley elements. The generated soundtrack is further configured to transition naturally across scenes, replicating the auditory expectations of a professionally produced film.

To support variable video durations, the system employs a single unified model that performs both direct audio generation conditioned on an input video and audio extension conditioned on a video with partially generated audio. The model can generate up to approximately thirty seconds of audio in a single forward pass, and extension techniques may be applied iteratively to achieve arbitrarily long outputs. For example, when generating long-form videos, the system can extend soundtracks across minutes by repeatedly appending new audio segments that remain temporally and semantically consistent with previously generated audio, as illustrated in the training and inference pipeline.

The audio extension mechanism is realized using a masked audio prediction strategy. In this approach, the model predicts a target segment of audio conditioned on the entire video input and the available surrounding audio context. The surrounding audio may be absent (corresponding to new audio generation), located before or after the target segment (corresponding to audio extension in either temporal direction), or distributed around the target segment (corresponding to audio infilling). Audio infilling is particularly useful for refining localized portions of the soundtrack, such as replacing sections with artifacts, noise, or unwanted sound effects, while preserving the integrity of the rest of the audio.

Lastly, for sound design purposes, users often require fine-grained control over how acoustic events are incorporated into a video. For example, a user may wish to emphasize certain on-screen sounds, introduce off-screen environmental effects, include or exclude background music, or specify stylistic attributes for the musical score. To accommodate these needs, the disclosed system enables text-based prompting for audio generation. A user may provide natural-language instructions that specify which audio elements should be emphasized, inserted, or modified, and in what style or mood those elements should be rendered. The model interprets these prompts in conjunction with the visual content of the video and generates corresponding soundtrack elements that align with the specified intent. This configuration allows both technical and non-technical users to design professional-quality audio tracks through intuitive text input, reducing the complexity of traditional sound design workflows while offering precise control over the auditory composition.

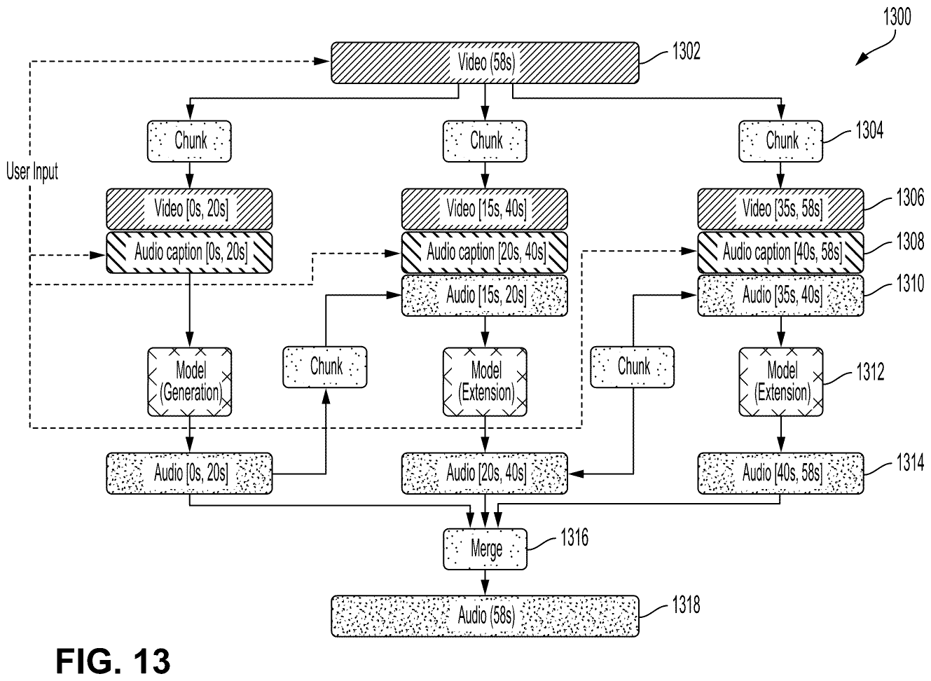

FIG. 13 illustrates an example audio extension pipeline 1300 for generating long-form audio tracks synchronized with video content, in accordance with various aspects of the present disclosure. As shown, the pipeline 1300 receives a video input 1302 of arbitrary duration (e.g., 58 seconds) along with user-provided input in the form of one or more audio captions 1308 that describe the desired soundtrack for each segment of the video.

The video 1302 is divided into temporal chunks 1304 to facilitate efficient audio generation. For example, the first chunk corresponds to a video segment 1306 spanning from 0 to 20 seconds, with an associated audio caption describing the desired soundtrack content for that interval. A generative audio model 1312 processes the video segment and the caption to produce an initial audio segment 1314 aligned to the first chunk (0-20 seconds (s)).

For subsequent video chunks, such as the segment from 15 s to 40 s or 35 s to 58 s, the pipeline introduces an extension mechanism. In these cases, the extension model 1312 receives not only the video segment 1306 and the corresponding audio caption 1308, but also a portion of the previously generated audio 1310. For example, the model may take the last 5 seconds of the preceding audio segment as an additional conditioning input. This overlapping context enables the model to generate the next segment of audio in a manner that ensures continuity and coherence with previously generated segments. In the example of FIG. 13, this results in the generation of audio segments for the intervals 20 s-40 s and 40 s-58 s.

Once all audio segments have been generated, the pipeline merges 1316 the outputs into a single continuous soundtrack 1318 aligned with the full video duration. This approach allows the system to generate coherent long-form audio for videos that exceed the maximum single-shot generation length of the underlying model.

By conditioning each subsequent chunk on overlapping segments of prior audio, the system ensures smooth transitions between audio chunks, preserving consistency in ambience, rhythm, mood, and acoustic texture. This design allows for high-quality audio tracks that can scale to arbitrary video lengths while remaining temporally synchronized with both the visual content and the user-provided audio captions.

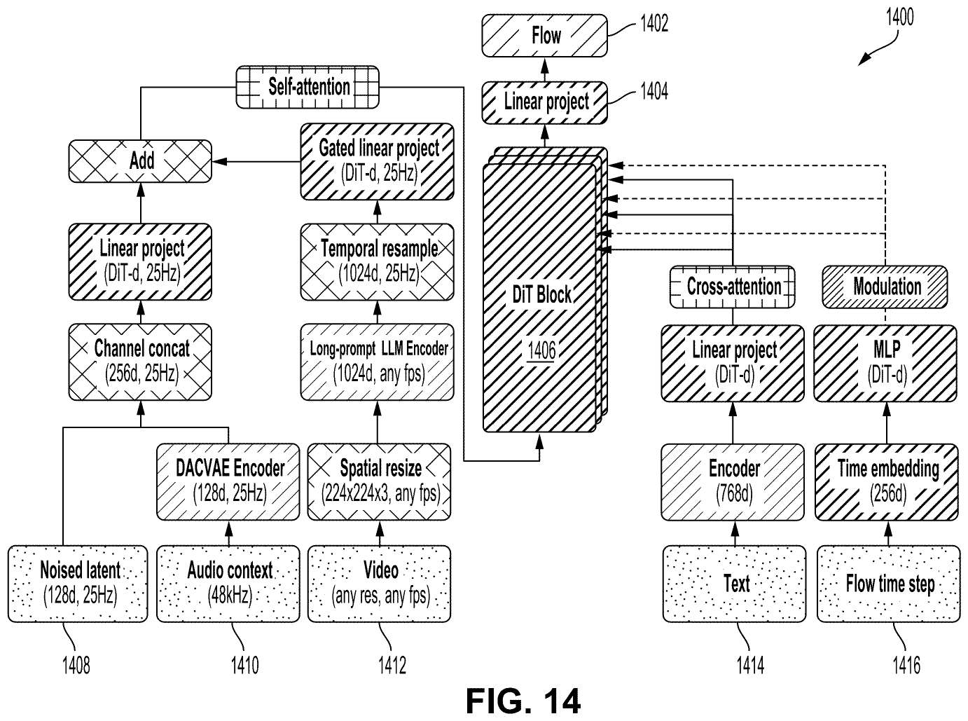

FIG. 14 illustrates an example architecture 1400 of a movie gen audio model configured to generate soundtracks conditioned on multimodal inputs, in accordance with various aspects of the present disclosure. In the example of FIG. 14, the multimodal inputs may include audio, video, and text. In this embodiment, the inputs may be the noised latent 1408, audio context 1410, video 1412, text 1414, and flow time step 1416. The pre-trained and frozen modules may include a domain-adaptive convolutional variational autoencoder (DACVAE) encode, long-prompt contrastive language-image based LLM, and/or a text-to-text transfer transformer based LLM. Non-learnable operations may include spatial resize, temporal resample, and channel concat. Learnable modules may include linear project 1414, gated linear project, the diffusion transformer (DiT) block 1407, MLP, and time embedding. The output velocity u(Xₜ, c, t; θ), shown as flow 1402. The conditioning input c includes masked audio context, video embeddings, and text features. The input Xₜ represents a noisy audio sample drawn from the flow distribution at time step t. The audio context is represented as DAC-VAE features, where masked frames are replaced with zero vectors such that the model can perform infilling or out-filling during audio generation. A noised latent 1408 of shape 128d at 25 Hz is combined with the audio context 1410, encoded at 48 kHz and compressed into DAC-VAE latent features, and concatenated along the channel dimension. The combined representation passes through a linear projection to align with the diffusion transformer (DiT) input space. The DAC-VAE encoder compresses audio waveforms into compact 1D latent features of shape TX 128 at 25 Hz. Compared to commonly used Encodec features (75 Hz, 128d) for 24 kHz audio, the DAC-VAE encoder achieves superior quality by supporting 48 kHz audio with higher fidelity at a lower frame rate, reducing periodicity artifacts through multi-scale short-time Fourier transform (STFT) discriminators and introducing periodic inductive biases using Snake activations. Quantization modules such as residual vector quantizers are removed in favor of a variational autoencoder formulation, which improves reconstruction performance, particularly at compressed frame rates.

Video inputs 1412 are processed through a spatial resize operation to normalize the resolution (e.g., 224×224) and then encoded using an encoder, such as the long-prompt contrastive language-image based LLM encoder, fine-tuned to produce 1024-dimensional embeddings for each frame. To synchronize video with audio, embeddings are temporally resampled to 25 Hz, matching the audio frame rate. These embeddings are projected into the DiT dimension using a gated linear projection, which provides a multiplicative control mechanism to modulate the influence of visual information on a frame-by-frame basis. This approach, which adds video features directly to audio features at corresponding frames, improves alignment compared to concatenating video and audio features along the temporal dimension.

Text inputs 1414 provide semantic-level conditioning in the form of audio captions. A T5-Base encoder transforms each text prompt into a sequence of 768-dimensional features capped at 512 tokens. The features are projected into the DiT dimension and integrated through cross-attention layers located after self-attention and before feed-forward modules in each DiT transformer block. This allows text to directly guide both low-level acoustic features and high-level semantic structures such as mood, sound event emphasis, and music style.

The DiT block 1406 serves as the core generative backbone and applies self-attention, cross-attention, and feed-forward layers, with outputs modulated by the flow time step. The flow time embedding 1416 is represented as a 256-dimensional vector processed by a multi-layer perceptron (MLP) to predict six modulation parameters, including four scales and two biases. These parameters are injected into normalization layers and attention layers across all transformer blocks. Unlike conventional DiT architectures, this implementation shares the MLP across layers with only layer-dependent biases added, reducing parameter count without loss of performance.

The output of the DiT block 1406 is linearly projected 1404 to generate the velocity field 1402, which defines the directional update of the audio latent representation at each flow step. This velocity guides the denoising process within the flow-matching framework, transforming noisy latent representations into coherent audio signals aligned with video frames and text prompts. By conditioning on audio context, noised latents, video embeddings, and textual captions, the architecture enables generation, extension, and infilling of cinematic-quality soundtracks. Operating in a compressed latent space with frozen pretrained encoders ensures both training and inference efficiency, while the flow-matching training objective improves stability, inference speed, and overall audio quality compared to diffusion-based models.

In some examples, the movie gen audio model is configured to perform one-shot generation during inference by selectively applying dropout to conditioning inputs during training. Each conditioning input, including video, audio context, and text, may be independently dropped out with certain probabilities. This training strategy enables the same model to support multiple inference modes without requiring task-specific models or retraining. For example, when both text and audio context are dropped out, the model performs video-to-audio (V2A) generation, producing an audio track solely from the visual content of the input video. When only the audio context is dropped out, the model performs text-instructed video-to-audio (TV2A) generation, in which the soundtrack is guided by both the video input and a text caption describing the desired acoustic events or musical properties. When only the text input is dropped out, the model performs video-to-audio infilling or extension, where missing or masked regions of an existing audio track are reconstructed or extended to align with the video content. Finally, when no conditioning input is dropped, the model performs text-instructed video-to-audio infilling or extension, allowing a user to specify detailed edits or additions to the soundtrack through natural language instructions while maintaining temporal alignment with the video. By applying dropout during training, the system achieves flexible conditioning at inference, enabling a single model to support diverse audio generation, extension, and editing tasks across a range of input modalities.

In some implementations, the movie gen audio model supports inference for audio extension, enabling the generation of coherent long-form soundtracks for videos whose durations exceed the maximum training length. Because training data is capped at a predetermined sequence length due to memory and efficiency considerations, direct training on arbitrarily long videos is not feasible. To address this limitation, the system employs algorithms that divide a long video into overlapping segments and then consolidate the segment-level predictions into a continuous output. This strategy ensures temporal coherence across the full duration of the video, while propagating information between adjacent segments through overlapping frames.

In one example, given a video input c_{vid} of length N frames, the video is divided into J=┌N/nₕₒₚ┐ overlapping segments, where each segment has a length of n_{win} frames and consecutive segments differ by nₕₒₚ frames. The resulting overlap between consecutive segments is n_{ctx}=n_{win}−nₕₒₚ frames. The j-th segment spans frames

$$[ {n}_{start}^{( j )} , {n}_{end}^{( j )} ] , where {n}_{start}^{( j )} = max ( 0 , ( j - 1 ) {n}_{hop} - {n}_{ctx} ) and$$

$${n}_{end}^{( j )} = min ( N , {jn}_{h o p} ) .$$

Each segment may be associated with a corresponding caption

$${c}_{t x t}^{( j )}$$

that provides semantic guidance for audio generation. At inference, the consolidated prediction for each segment at flow step tit_iti is denoted as

$${X}_{{t}_{i}}^{( j )} ,$$

where

$${\{ {t}_{i} \}}_{i = 1}^{T}$$

is a common flow time schedule with t₁=0, t_{T}=1, and tᵢ<tᵢ₊₁ for all i. The initialization state

$${X}_{0}^{( j )}$$

represents noise sampled from a prior distribution p₀, and the terminal state

$${X}_{1}^{( j )}$$

represents the predicted audio sequence for the segment.

Two extension methods may be used to merge and align segment-level predictions: segment-level autoregressive generation and multi-diffusion. In the segment-level autoregressive approach, segments are generated sequentially, with each segment conditioned on information carried forward from the preceding segment. Context propagation occurs by incorporating the final n_{ctx} frames of the prior segment as conditioning input for the next segment, ensuring continuity across the overlap region. The model may also apply trajectory regularization to blend intermediate flow trajectories of overlapping frames, smoothing transitions between segments. Enhancements such as beam search may be employed at the segment level to generate multiple candidate trajectories, rank them with a scoring model, and retain the most promising candidates as prefixes for subsequent segments.

In the multi-diffusion approach, segment predictions are generated in parallel across flow steps rather than sequentially. At each flow step, the latent state is divided into segment-level representations, each updated by the generative model using the corresponding conditioning inputs. The updated segments are then merged into a global latent representation by applying zero-padding and soft-masking functions. The masks define the contribution of each segment to overlapping frames, and are normalized such that contributions across all segments sum to unity for every frame. Empirical results show that triangular window functions yield smoother transitions at segment boundaries compared to uniform masks, thereby improving perceptual quality. Unlike the autoregressive method, which fully completes the denoising trajectory for one segment before beginning the next, multi-diffusion advances all segments synchronously across flow steps, leading to improved temporal consistency and reduced discontinuities.

Both methods enable audio generation beyond the training sequence length, but multi-diffusion has demonstrated superior empirical performance in producing high-quality, seamless long-form soundtracks, and may be employed as the default method.

In some implementations, the system employs a segment-level autoregressive generation algorithm to extend audio across long videos. This approach emulates autoregressive language models, but operates at the level of video segments rather than individual tokens. In particular, the model generates one segment at a time, with each segment conditioned on information carried forward from the last n_{ctx} frames of the preceding segment. Given a prediction trajectory

$${X}_{{t}_{i}}^{( j )}$$

from the j-th segment, information may be propagated into the trajectory

$${X}_{{t}_{i}}^{( j + 1 )}$$

of the subsequent segment through two complementary mechanisms: context conditioning and trajectory regularization.

In the context conditioning path, the audio context

$${c}_{c t x}^{( j + 1 )}$$

for the next segment is updated using the terminal portion of the previous segment's output. Specifically, the audio context

$${c}_{c t x}^{( j + 1 )}$$

is defined as

$$[ {X}_{1 , - {n}_{ctx}}^{( j )} ; 0 ] ,$$

where

$${X}_{1 , - {n}_{ctx}}^{( j )}$$

denotes the last n_{ctx} frames of the predicted audio

$${X}_{1}^{( j )}$$

for segment j, and 0 denotes a zero matrix of shape nₕₒₚ×C, with C representing the number of feature channels. This configuration supplies the overlapping frames as context while maintaining zeros for the newly advancing portion of the segment.

In the trajectory regularization path, information is propagated by blending the flow trajectories of the overlapping region at each flow step. At flow step tᵢ, the current segment's state is updated using the solution of the ODE solver, denoted

$${\hat{X}}_{{t}_{i + 1}}^{( j + 1 )} = ODE - Solve ( u , {X}_{{t}_{i}}^{( j + 1 )} , {c}^{( j + 1 )} , {t}_{i} , {t}_{i + 1} ) ,$$

where the inputs include the prior state

$${X}_{{t}_{i}}^{( j + 1 )} ,$$

the conditioning triplet

$${c}^{( j + 1 )} = \{ {c}_{v i d}^{( j + 1 )} , {c}_{c t x}^{( j + 1 )} , {c}_{t x t}^{( j + 1 )} \}$$

and the flow model u. The overlapping region of the state is then updated as

$${X}_{{t}_{i + 1} , 0 : {n}_{ctx}}^{( j + 1 )} = w ⊙ {\hat{X}}_{{t}_{i + 1} , 0 : {n}_{ctx}}^{( j + 1 )} + ( 1 - w ) ⊙ {X}_{{t}_{i + 1} - {n}_{ctx} :}^{( j )} ,$$

where ⊙ denotes element-wise multiplication and

$$w ∈ {R}_{\geq 𝕆}^{{n}_{c t x}}$$

is a weighting function. Frames outside the overlap are left intact, i.e.,

$${X}_{{t}_{i + 1} , {n}_{c t x} : {n}_{w i n}}^{( j + 1 )} = {\hat{X}}_{{t}_{i + 1} , {n}_{c t x} : {n}_{w i n}}^{( j + 1 )} .$$

At the conclusion of the denoising process, the audio of the overlapping frames is update again using the consolidated prediction from the later segment, denoted

$${X}_{1 , 0 : {n}_{ctx}}^{( j + 1 )} .$$

The weighting function w governs the smoothness of the transition. To reduce discontinuities, a linear ramp function is used, defined as wₙ=n/n_{ctx} for w∈[n_{ctx}]. In this configuration, frames near the beginning of the overlap are weighted more heavily toward the preceding segment, while frames closer to the end of the overlap are weighted more heavily toward the current segment, resulting in a gradual and perceptually smooth handoff between segments.

In some examples, performance of segment-level autoregressive generation is further enhanced using beam search. At each segment boundary, multiple candidate predictions are generated, and a scoring model ranks and prunes these candidates. The highest-ranked candidates are then propagated as prefixes for generating subsequent segments. This beam search approach improves temporal coherence, motion alignment, and global quality of the long-form audio output.

In some examples, multi-diffusion is employed as an audio extension technique that parallels prior success in using diffusion models trained on relatively small images (e.g., 512×512 resolution) to generate much wider panoramas and in video upsampling tasks. Conceptually, multi-diffusion is formulated as the audio counterpart of panorama generation. Rather than generating one segment at a time in sequence, as in segment-level autoregressive generation, multi-diffusion solves the ordinary differential equation (ODE) across all segments in parallel for each time step, consolidates the intermediate results, and then advances to the next time step. To initialize the process, an audio latent X₀ is sampled from a prior distribution p₀. At each flow step tᵢ, the latent Xₜ_{ᵢ} is split into segment-specific chunks

$${\{ {X}_{{t}_{i}}^{( j )} \}}_{j}$$

based on predefined segmentation boundaries. For each segment, an updated latent

$${\hat{X}}_{{t}_{i}}^{( j )}$$

is computed using the ODE solver as

$${\hat{X}}_{{t}_{i + 1}}^{( j )} = ODE - Solve ( u , {X}_{{t}_{i}}^{( j )} , {c}^{( j )} , {t}_{i} , {t}_{i + 1} ) .$$

The updated per-segment predictions are then merged into a consolidated sequence according to

$${X}_{{t}_{i + 1}} = {\sum }_{j} zero - pad ( {m}^{( j )} ⊙ {\hat{X}}_{{t}_{i + 1}}^{( j )} , j ) ,$$

where
the function zero-pad(X^{(j)}, j) maps the segment of shape n_{win}×C back into the full sequence of shape N×C by padding zeros before and after the segment's range

$${n}_{s t a r t}^{( j )}$$

to

$${n}_{e n d}^{( j )} .$$

### Here

$${n}_{s t a r t}^{( j )} = max ( 0 , ( j - 1 ) {n}_{w i n} - {n}_{w i n} ) and {n}_{e n d}^{( j )} = ( N , {jn}_{hop} ) .$$

The soft-masking function

$${m}^{( j )} ∈ {ℝ}_{\geq 0}^{{n}_{w i n}}$$

specifies the contribution of each segment to the consolidated prediction across the frames it spans, with the constraint that contributions from all segments sum to one at each frame, i.e., Σⱼzero−pad(m^{(j)},j)=1. This step is repeated until the final flow step t_{T}=1 is reached, yielding the completed extended audio sequence.

Soft-masking functions can be designed to regulate how segment predictions blend, thereby influencing continuity across boundaries. A uniform window function \hat{m}^{(j)}=1 produces equal weighting, as used in prior approaches, but may introduce abrupt transitions at segment boundaries where predictions diverge. Alternatively, a triangular (Barlett) window function, defined as

$${\hat{m}}_{n}^{( j )} = \frac{2}{{n}_{w i n} - 1} ( \frac{{n}_{w i n} - 1}{2} - \vert n - \frac{{n}_{w i n} - 1}{2} \vert ) ,$$

achieves smoother transitions by gradually shifting weights from one segment to the next. Empirical evaluations confirm that triangular weighting reduces discontinuities in the overlapping regions, producing higher quality and more coherent long-form audio generation, similar in effect to linear ramping functions used in autoregressive approaches.

In some examples, a diffusion transformer (DiT) model comprising thirty-six layers and an attention/feed-forward dimension of 4,608/18,432 is employed. The layers and dimensions of the DiT are exemplary, other sizes for the layers and dimensions may be used. The DiT model includes a large quantity of parameters, excluding the parameters of auxiliary encoders, such as long-prompt contrastive language-image based LLM, text-to-text transfer transformer, and/or DAC-VAE. During training, videos may be capped, such as being capped at thirty seconds (750 frames), with longer clips randomly chunked. For finetuning, segments, such as ten-second and thirty-second segments, may be randomly sampled. Fully sharded data parallelism is used to accommodate the model size. Training is conducted in two stages, pre-training and fine-tuning, which utilize the same objective but differ in the underlying datasets and optimization configurations.

In certain implementations, pre-training may be performed using a large effective batch size with training sequences capped at a predetermined maximum duration or token length. Pre-training may proceed for a specified number of updates across a distributed set of processing units, such as GPUs or other accelerators, and may employ a learning rate schedule that begins with a warm-up phase followed by training at a substantially constant rate. During fine-tuning, the model may be trained with a smaller effective batch size, while still capping sequences at the same maximum duration or token length. Fine-tuning may be performed for a reduced number of updates and may employ a learning rate schedule that linearly increases to a target value during an initial ramp-up period and then gradually decays to a lower value during the remainder of training.

In some examples, an exponential moving average checkpoint of model weights is maintained throughout training, with a decay factor chosen to stabilize inference performance. Both pre-training and fine-tuning may utilize an optimizer such as, for example, AdamW optimizer or other weight-decay-based optimizers, combined with reduced precision training (e.g., fp16 (16-bit floating-point (also referred to herein as 16-bit half-precision floating-point)), or equivalent formats) to improve efficiency.

Classifier-free guidance is supported during inference by dropping conditioning inputs, including video, text, and audio context, with a probability of 0.2 during training. To support both audio generation and audio extension, masked audio inputs are either completely masked with a probability of 0.5, or otherwise masked between 75% and 100%. Text and video inputs are independently dropped with a probability of 0.1 each, thereby reducing overreliance on any single modality.

In certain implementations, inference may be performed using a numerical solver configured with a fixed number of steps, although alternative solvers or step counts may be employed without substantially impacting performance. Classifier-free guidance may be applied with a weighting factor to balance unconditional and conditional components of the model output. In some examples, multiple candidate outputs are generated per input and subsequently reranked based on one or more quality metrics. Quality thresholds may be set according to the intended use case, such as differentiating between sound effect generation and joint sound effect with music generation.

For audio extension tasks, inference may employ dynamic guidance in combination with multi-diffusion techniques. The multi-diffusion process may utilize overlapping windows defined by configurable parameters such as window size, hop size, and context length. These parameters may be adjusted depending on the available computational resources and the desired smoothness and coherence across extended audio segments.

In certain implementations, the relationship between audio and visual components of a video is modeled and classified to improve the generation, editing, or alignment of multimodal content. Audio and visual features exhibit different levels of correlation. For example, some sound effects, such as footsteps, correlate with low-level motion features of objects or humans within the scene. Other sounds, such as canned laughter in a sitcom, correlate with high-level semantic events, such as when humorous content occurs. Similarly, musical elements may originate from sources present within the video (e.g., a musician performing on screen) or may be added during post-production to enhance narrative or emotional impact.

To capture these complexities, audio is classified along two orthogonal axes. The first axis relates to audio type. In one implementation, audio types include at least voice (comprising both speech and singing), non-vocal music, and general sounds (which may include environmental sounds, Foley effects, and other non-musical audio). Automatic classification along this axis may be performed by an audio event detection (AED) model, such as those trained to identify multiple concurrent audio types within a sample.

The second axis relates to whether the audio is diegetic or non-diegetic. Diegetic audio components are those that are perceivable within the scene and bear a causal relationship to the video content. Examples include conversations between people, narration by on-screen newscasters, live music performed within the scene, or ambient environmental sounds such as birds chirping. Diegetic sounds may be on-screen or off-screen; for example, bird chirps remain diegetic even when the birds are not visually depicted. Diegetic sounds may also be original recordings from the environment or artificially produced post-production sounds (i.e., Foley). By contrast, non-diegetic audio components are external to the scene, such as narration in a documentary, background scoring in a film, or canned laughter added during post-production. Many professionally produced videos, such as movies and television programs, contain a combination of both diegetic and non-diegetic sounds.

In some implementations, the classification of diegetic versus non-diegetic audio is performed using a contrastive audio-video-text pre-training (CAVTP) model. Such a model determines the likelihood that an audio segment is diegetic with respect to the corresponding video. Because the CAVTP model is trained on corpora that predominantly include diegetic sounds, the embeddings of diegetic audio samples and corresponding video features exhibit higher similarity (e.g., cosine similarity) than non-diegetic counterparts. Thus, diegetic audio is inferred where audio-video embeddings are closer in feature space, while non-diegetic audio is inferred where embedding similarity is relatively low.

In some examples, the system generates different classes of sounds by learning distinct relationships between the audio output and its conditioning inputs. Diegetic on-screen sounds align tightly with visual events: the movie gen audio model predicts what sound occurs and when with near-deterministic timing, which pushes the backbone to perform strong video understanding and dense action recognition. The difficulty scales with the structure and density of events; producing short, impulsive general sounds (e.g., a golf club striking a ball) is typically easier than rendering instrument performance that must match fine motor actions and chord fingering. Diegetic off-screen sounds require scene-level reasoning rather than frame-localized alignment. The movie gen audio model infers which sounds plausibly occur in a depicted environment (e.g., birds in a forest) and orders events logically in time (e.g., crowd cheering follows a successful trick rather than preceding it). Non-diegetic audio correlates with the video at a semantic and affective level. Background music should track mood and narrative beats, and transitional effects (e.g., risers) should build tension or anticipation; achieving this demands high-level understanding that goes beyond physical causality to modeling intent and emotion.

In some examples, the system targets diegetic general sounds, non-diegetic sound effects, and instrumental music. The system does not generate diegetic speech when transcripts are unavailable and when video artifacts complicate lip-synchronization, and it omits non-diegetic speech because off-the-shelf text-to-speech systems can produce it from scripts. Because correlations exist both between video and audio and across audio classes themselves, the system trains a single model that jointly generates all supported classes rather than maintaining separate models for diegetic/non-diegetic and vocal/music/sound-effect categories. This unified approach lets the movie gen audio model share representations for timing, scene context, and affect, improving coherence across mixed soundscapes.

In certain implementations, pre-training is configured to teach the model both the structural properties of audio and the alignment between audio, video, and text using large volumes of multimodal data. Such data may include both high-quality and low-quality audio samples. To ensure that the resulting training set captures meaningful signals, filtering criteria based on audio event detection (AED) tags and contrastive audio-video-text pre-training (CAVTP) scores are applied.

In one approach, raw data is first sourced at scale and each audio sample is tagged using an audio event detection (AED) model, which may comprise audio event classes (e.g., 527 distinct audio event classes, or other distinct audio event classes). Samples where silence is identified as the dominant class are excluded from further processing. The remaining audio events are mapped into one of three higher-level categories: (i) “voice,” which includes any subclass of speech or singing as defined in an ontology; (ii) “music,” which includes any subclass associated with non-vocal music; and (iii) “sound,” which encompasses all other subclasses not covered by the first two categories. As a result, a given utterance may contain one or more of these categories simultaneously.

Once categorized, samples are grouped according to audio type and further processed using CAVTP scores, which quantify the similarity between audio and video embeddings derived from a contrastive audio-video-text model. The cosine similarity value from CAVTP is used to assign each sample to a corresponding quality bucket, where thresholds for these buckets are empirically determined through manual inspection and validation. This ensures that pre-training emphasizes samples with meaningful correspondence between modalities, while still retaining sufficient variability to improve model robustness.

In certain embodiments, noise reduction from the visual modality is achieved by applying a sequence of quality filters to remove unsuitable video samples prior to training. Videos containing embedded text are excluded using optical character recognition (OCR) techniques. Videos that are static, or that fail to meet a minimum resolution threshold (e.g., less than 480 pixels in height), are also removed from the training corpus. To further constrain the training data to visually coherent samples, video lengths are limited to a range between approximately four seconds and one hundred and twenty seconds. In addition, visual deduplication is performed using copy-detection embeddings to eliminate perceptually duplicate or near-duplicate videos from the dataset. Collectively, these filtering steps ensure that the training data consists of high-quality, diverse, and non-redundant visual samples, thereby improving the effectiveness of multimodal pre-training.

Once pre-training establishes foundational knowledge of audio structure and cross-modal alignment, a fine-tuning phase is employed to align the model outputs with the qualities expected of cinematic soundtracks, which differ substantially from general-purpose recordings such as those captured on consumer devices (e.g., mobile phones or security cameras). Cinematic soundtracks are typically captured using professional-grade microphones and undergo post-production steps such as mixing and mastering to eliminate unwanted noise artifacts (e.g., microphone pops, wind interference) and to balance audio components. These processes enhance key storytelling elements by suppressing irrelevant ambient noise, attenuating off-screen sounds, emphasizing salient audio events such as explosions or dialogue, and blending music tracks with transitions such as fade-in or fade-out.

Broadly, cinematic soundtracks differ from low-quality recordings in two dimensions: audio quality (how the soundtrack sounds) and sound design (what sounds are included). To bridge this gap, fine-tuning incorporates two curated sources of training data. The first source, referred to as the cinematic split, consists of professionally produced clips that include both diegetic and non-diegetic components such as ambient and thematic music, while excluding vocals. Clips are filtered automatically using an audio-visual cinematic classifier and an audio event detection (AED) model, followed by manual human annotation to ensure quality and relevance. The second source, referred to as the high-quality audio split, consists of large-scale, high-quality audio-only data comprising approximately O(10)K hours of music and O(10)K hours of sound effects without corresponding videos. This second source provides a greater quantity than the cinematic split and is leveraged to further improve audio fidelity.

During fine-tuning, the two datasets are combined with a ratio of approximately ten batches of cinematic video data to one batch of high-quality audio-only data. This balanced approach ensures that the fine-tuned model maintains strong cinematic sound design alignment while also benefiting from improvements in raw audio quality derived from large-scale audio-only training.

To provide precise control during training and inference, each audio sample is annotated with a synthetic caption composed of distinct parts, such as, but not limited to: audio quality, voice and music presence, sound caption, and music style caption. This structured captioning system enables the model to condition its generation on both objective quality scores and semantic descriptors of the audio. Audio quality is represented as a real-valued score between one and ten, predicted by an audio quality model trained using annotations collected in a manner associated with aesthetic scoring, where ten corresponds to the highest perceptual quality and one corresponds to the lowest. Voice and music presence are determined by the audio event detection (AED) model. Voice presence is expressed as a binary indicator derived from a posterior probability threshold, while music presence is represented using the AED posterior probability directly, as certain cinematic sound effects (e.g., risers) may ambiguously resemble music.

The sound caption is generated by a general-purpose audio captioning model that produces a free-form natural language description of the auditory content. To improve controllability of musical aspects, a specialized music captioning model is further employed to provide detailed annotations of musical mood, genre, and style. A music caption is appended to every training sample, regardless of whether music is actually present. This ensures that music-related conditioning is consistently available to the model. In practice, combining the probabilistic music presence from the AED model with the descriptive music caption yields the most reliable control, as the music caption model, trained primarily on musical data, tends to hallucinate when applied to non-musical inputs.

To support training at multiple temporal resolutions, each audio sample is divided into both ten-second and thirty-second chunks. Captions are generated for each chunk, with the chunks drawn from the final segment of a sequence to ensure alignment with natural clip boundaries. During training, the shorter ten-second samples are emphasized, with batches sampled at a ratio of five to one relative to thirty-second samples, thereby balancing training efficiency with coverage of longer contexts.

For example, one caption may specify: “This audio has quality: 8.0. This audio does not contain speech. This audio does not contain vocal singing. This audio has a description: ‘gentle waves lapping against the shore, and music plays in the background.’ This audio contains music with a 0.90 likelihood. This audio has a music description (if applicable): ‘A beautiful, romantic, and sentimental jazz piano solo.’” Another caption may read: “This audio has quality: 7.0. This audio does not contain speech. This audio does not contain vocal singing. This audio has a description: ‘fireworks exploding with loud booms and crackles.’ This audio contains music with a 0.01 likelihood. This audio has a music description (if applicable): ‘A grand, majestic, and thrilling orchestral piece featuring a massive symphony orchestra with a soaring melody and pounding percussion, evoking a sense of awe and wonder.’” These examples illustrate how the captions incorporate objective parameters, such as audio quality scores and probabilistic assessments of music presence, together with semantic descriptions of sounds and stylistic information. This combination of structured elements provides comprehensive supervision signals that allow the model to learn both technical aspects of audio quality and higher-level semantic and stylistic relationships.

The disclosed system of foundation models, referred to collectively as movie gen, represents a comprehensive framework for advancing multimodal media generation. The movie gen suite includes multiple specialized models, such as, but not limited to: movie gen video, which performs large-scale text-to-video generation; personalized text-to-video (PT2V), which preserves identity in generated videos through conditioning on reference images; movie gen edit, which provides instruction-guided video editing without reliance on supervised editing datasets; and movie gen audio, which generates synchronized ambient sounds, sound effects, and instrumental music. Together, these foundation models deliver substantial improvements in text-to-video generation, video personalization, video editing, and soundtrack creation.

These improvements are achieved by coordinated scaling across three axes—data volume, training compute, and model size—demonstrating that simultaneous scaling of all three factors yields significant performance gains. The training methodology emphasizes a multi-stage strategy. Pre-training leverages very large but diverse datasets, including both video-text and image-text pairs, to establish foundational knowledge of structure and alignment. Fine-tuning then uses smaller but higher-quality curated datasets to refine output aesthetics, temporal coherence, and fidelity. This general recipe has been shown to be effective across image, video, and audio modalities.

A novel approach for video editing is introduced, equipping a strong video foundation model with editing capabilities through multi-task training that alternates between image editing and video generation, followed by refinement stages, such as, but not limited to: training on synthetic multi-frame editing data, and backtranslation-based training with real videos to enhance motion naturalness and reduce artifacts. PT2V achieves personalization by means of a staged training process that injects identity features, extends to long-video generation, and improves naturalness using cross-paired data. Movie Gen Audio leverages a diffusion transformer architecture trained with Flow Matching in a continuous latent audio space, conditioned on video, text, and masked audio context, with long-form audio generation supported through segment-level autoregression and multi-diffusion techniques.

Despite these advancements, certain limitations remain. Generated or edited videos may still exhibit artifacts around complex geometries, object manipulations, physical interactions, or state transformations. Generated audio may fall out of synchronization in scenarios with dense or occluded motion, or when fine-grained recognition (e.g., guitar chords) is required. The present implementation excludes speech and singing by design, focusing instead on general sounds, sound effects, and instrumental music.

Reliable evaluation of media generation also remains a challenge. Human evaluations are subjective and influenced by personal biases, while many benchmarks rely on curated examples or opaque systems. To address this, the disclosed framework provides non-curated generations alongside standardized prompt sets, enabling transparent and reproducible comparisons across models.

Finally, while the disclosed models are currently trained separately for video and audio, an important future direction is the development of joint multimodal systems that generate temporally aligned and semantically consistent outputs across both modalities within a unified framework. Such systems are expected to further improve realism, controllability, and user experience across a wide range of applications.

The present disclosure provides a comprehensive framework for multimodal media generation, encompassing multiple synergistic innovations that, individually and collectively, advance the state of the art. In particular, aspects of the present disclosure may be categorized into one or more aspects or combinations thereof.

In some aspects, the disclosure provides a unified system that enables automatic generation of complete short films from user prompts. The system integrates large foundation models for script generation, scene layout, character and environment rendering, and synchronized audio production. This pipeline eliminates the need for manual stitching of separate tools or human intervention across stages, thereby delivering a seamless, fully automated process from initial prompt to final audiovisual output.

In other aspects, the disclosure addresses the challenge of maintaining consistent character identity across multiple scenes and shots. The system introduces reference image injection, in which identity features extracted from an input image are fused with video generation through cross-attention. This conditioning mechanism allows the generated character to preserve likeness and attributes across different prompts and contexts without repeated fine-tuning or manual re-specification of features.

In other aspects, the disclosure introduces a method for natural language-based video editing without reliance on supervised video editing datasets. The system is trained using a three-stage synthetic data procedure that combines single-frame editing, synthetic multi-frame editing, and backtranslation. This training regime allows the model to apply editing instructions such as adding, removing, or transforming objects in a video while preserving temporal coherence and visual fidelity, all in the absence of human-annotated video editing data.

In other aspects, the disclosure provides a single audio foundation model that generates instrumental music, ambient sound, and sound effects in response to either textual input or video content. The model is trained with multimodal conditioning and employs reinforcement or reward-based optimization and segmental reranking to align generated audio with the semantics and timing of visual content. This unified design allows coherent soundtrack creation without reliance on separate specialized models for music, sound, or ambient audio.

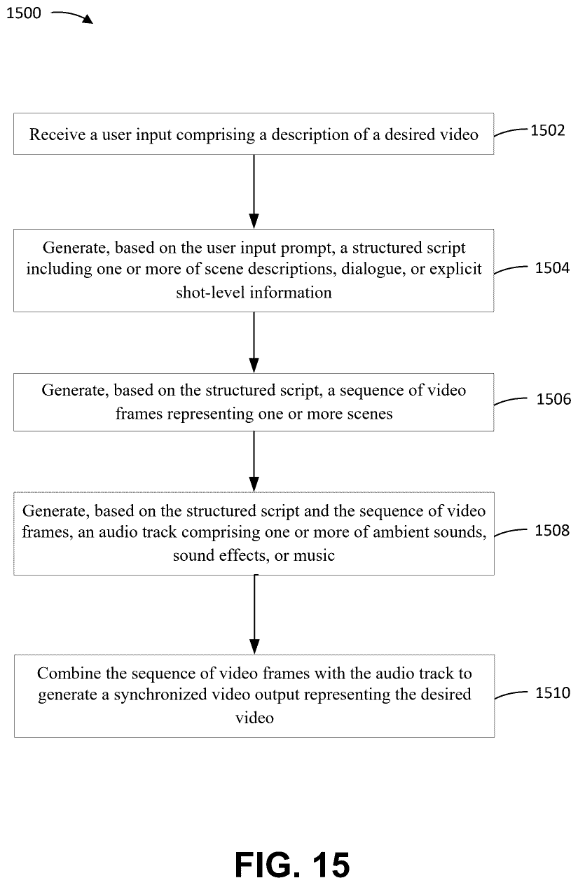

FIG. 15 is a flow diagram illustrating an example of a process 1500 for end-to-end script-to-movie generation, in accordance with various aspects of the present disclosure. The process 1500 may be performed by a movie generation system (e.g., move gen suite of models) described in accordance with various aspects of the present disclosure. The process 1500 begins at block 1502 by receiving an input video comprising a sequence of frames. At block 1504, the process 1500 receives an editing instruction expressed in natural language. At block 1506, the process 1500 generates a multimodal condition based on the textual editing instruction and the input video. The multimodal condition may include an embedding of the input video concatenated with an embedding of the textual editing instruction. At block 1508, the process 1500 applies, via a video editing model, the multimodal condition to modify visual content of the input video. At block 1510, the process 1500 generates an edited video comprising visual modifications corresponding to the textual editing instruction. The edited video preserving temporal coherence and overall visual fidelity of the input video.

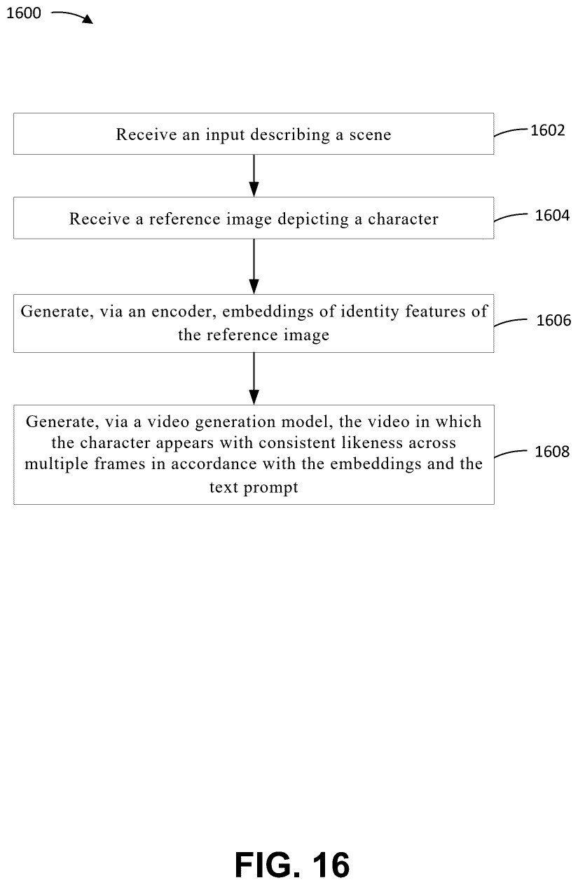

FIG. 16 is a flow diagram illustrating an example of a process 1600 for maintaining consistent character identity across generated video scenes, in accordance with various aspects of the present disclosure. The process 1600 may be performed by a video personalization system (e.g., PT2V model), described in accordance with various aspects of the present disclosure.

The process 1600 begins at block 1602 by receiving an input describing a scene. At block 1604, the process 1600 receives a reference image depicting a character. At block 1606, the process 1600 generates, via an encoder, embeddings of identity features of the reference image. At block 1608, the process 1600 generates, via a video generation model, a video in which the character appears with consistent likeness across multiple frames in accordance with the embeddings and the scene description.

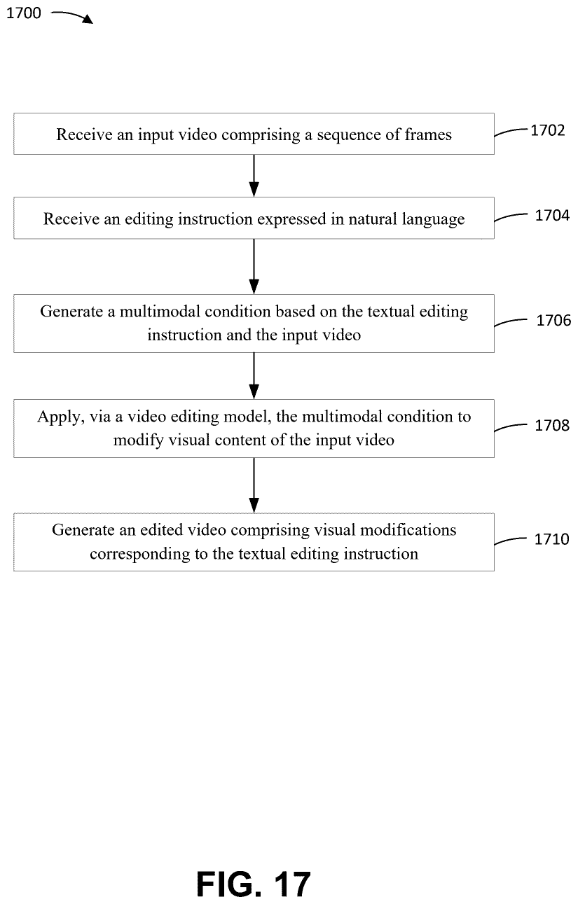

FIG. 17 is a flow diagram illustrating an example of a process 1700 for performing instruction-based video editing, in accordance with various aspects of the present disclosure. The process 1700 may be performed by a video editing model, described in accordance with various aspects of the present disclosure.

The process 1700 begins at block 1702 by receiving an input video comprising a sequence of frames. At block 1704, the process 1700 receives an editing instruction expressed in natural language. At block 1706, the process 1700 generates a multimodal condition based on the textual editing instruction and the input video. The multimodal condition may include an embedding of the input video concatenated with an embedding of the textual editing instruction. At block 1708, the process 1700 applies, via the video editing model, the multimodal condition to modify visual content of the input video. At block 1710, the process 1700 generates an edited video comprising visual modifications corresponding to the textual editing instruction, the edited video preserving temporal coherence and overall visual fidelity of the input video.

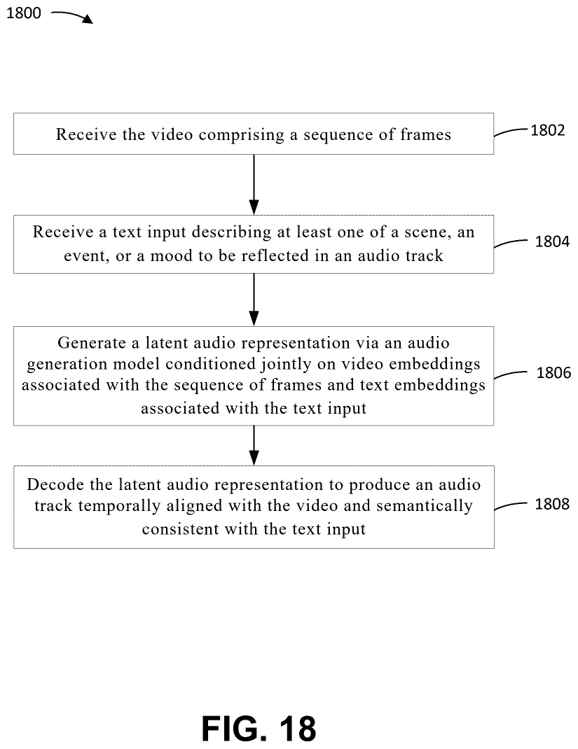

FIG. 18 is a flow diagram illustrating an example of a process 1800 for unified audio generation from text and video inputs, in accordance with various aspects of the present disclosure. The process 1800 may be performed by an audio generation model, described in accordance with various aspects of the present disclosure.

The process 1800 begins at block 1802 by receiving a video comprising a sequence of frames. At block 1804, the process 1800 receives a text input describing at least one of a scene, an event, or a mood to be reflected in an audio track. At block 1806, the process 1800 generates a latent audio representation via an audio generation model conditioned jointly on video embeddings associated with the sequence of frames and text embeddings associated with the text input. At block 1808, the process 1800 decodes the latent audio representation to produce an audio track that is temporally aligned with the video and semantically consistent with the text input.

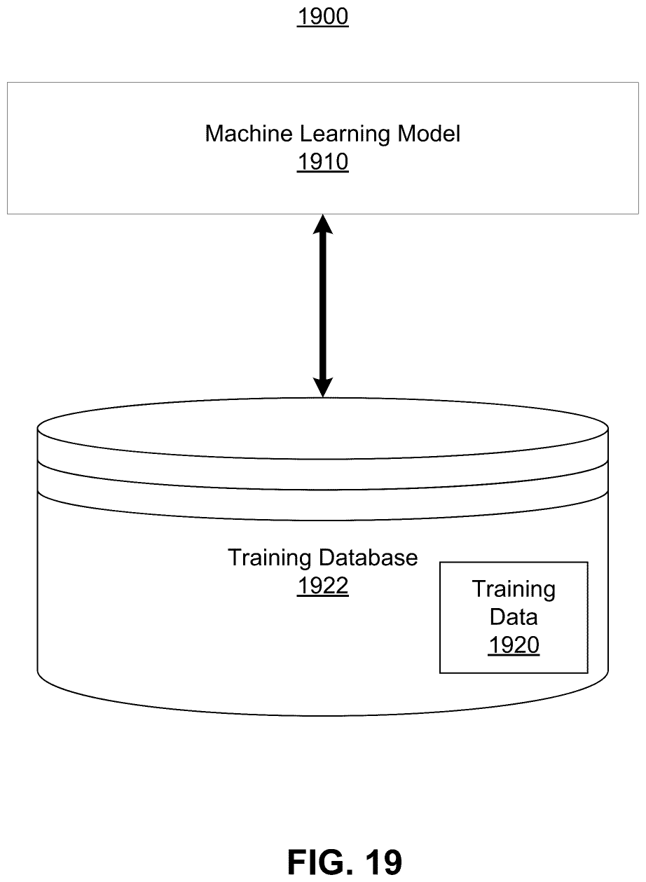

FIG. 19 illustrates a machine learning and training model, in accordance with various aspects of the present disclosure. The machine learning framework 1900 associated with the machine learning model(s) 1910 may be hosted remotely. Alternatively, the machine learning framework 1900 may reside within a server 162 shown in FIG. 1, or be processed by an electronic device (e.g., head-mounted displays, smartphones, tablets, smartwatches, or any electronic device, such as communication device 105, UE 30, etc.). The machine learning model(s) 1910 may be communicatively coupled to the stored training data 1920 in a memory or database (e.g., ROM, RAM). In some examples, the machine learning model 1910(s) may be associated with operations of any one or more of the systems/architectures depicted in subsequent figures of the application. In some other examples, the machine learning model(s) 1910 may be associated with other operations. For example, the machine learning model(s) 1410 may be associated with the processes 1500, 1600, 1700, and 1800 described with reference to FIGS. 15, 16, 17, and 18 respectively, and/or the system architecture 500, 600, 700, 800, 900, 1000, 1100, 1200, 1300, 1400 described with reference to FIGS. 5, 6, 7, 8, 9, 10, 11, 12, 13 and 14, respectively. The machine learning model 1910 may be implemented by one or more machine learning models(s) and/or another device (e.g., a server and/or a computing system (e.g., computing system 300)). In some embodiments, the machine learning model(s) 1910 may be a student model trained by a teacher model, and the teacher model may be included in the training database 1922.

In the present disclosure, the “system” may be an example of a generative AI platform, such as a platform associated with the processes 1500, 1600, 1700, and 1800 described with reference to FIGS. 15, 16, 17, and 18 respectively, and/or the system architecture 500, 600, 700, 800, 900, 1000, 1100, 1200, 1300, 1400 described with reference to FIGS. 5, 6, 7, 8, 9, 10, 11, 12, 13 and 14, respectively. Such a platform may operate across client applications and back-end services to manage consent, ingest and store capture data, evaluate prompts, and generate video and/or audio outputs.

Implementation examples are described in the following numbered clauses:
Clause 1. A method for generating a video, comprising: receiving a user input comprising a description of a desired video; generating, based on the user input prompt, a structured script including one or more of scene descriptions, dialogue, or explicit shot-level information; generating, based on the structured script, a sequence of video frames representing one or more scenes; generating, based on the structured script and the sequence of video frames, an audio track comprising one or more of ambient sounds, sound effects, or music, the generated audio track being temporally synchronized with the sequence of video frames; and combining the sequence of video frames with the audio track to generate a synchronized video output representing the desired video.
Clause 2. The method of Clause 1, wherein generating the structured script comprises generating a multi-scene screenplay comprising scene-by-scene breakdowns of one or more of characters, environments, or actions.
Clause 3. The method of any one of Clauses 1-2, wherein the sequence of video frames is generated via a video foundation model trained jointly on text-to-image and text-to-video tasks.
Clause 4. The method of any one of Clauses 1-3, wherein generating the sequence of video frames comprises encoding temporal dynamics including object motion, camera motion, and subject-object interactions.
Clause 5. The method of any one of Clauses 1-4, wherein the audio track is generated via an audio generative model conditioned on both textual and visual input to align generated sound events with corresponding visual events.
Clause 6. The method of any one of Clauses 1-5, wherein combining the sequence of video frames with the audio track comprises synchronizing onset times of sound effects with detected actions in the video frames.
Clause 7. The method of any one of Clauses 1-6, further comprising editing the structured script in response to a second user prompt prior to generating the sequence of video frames.
Clause 8. The method of any one of Clauses 1-7, wherein the desired video is generated at a base resolution, and the method further comprises applying a spatial upsampler to the video to generate a high-definition video output.
Clause 9. The method of any one of Clauses 1-8, wherein: the first generative model is a large language model trained on screenplay data; and the first generative model is configured to output the structured script in a machine-readable format comprising one or more of scene headers, action descriptions, dialogue lines, or camera directives.
Clause 10. An apparatus comprising at least one means for performing any one of Clauses 1-9.
Clause 11. A computer program comprising code for causing an apparatus to perform any one of Clauses 1-9.
Clause 12. An apparatus comprising one or more processors, one or more memories coupled with the one or more processors, and instructions stored in the memory and operable, when executed by the one or more processors to cause the apparatus to perform any one of Clauses 1-9.
Clause 13. A method for generating a video, the method comprising: receiving an input describing a scene; receiving a reference image depicting a character; generating, via an encoder, embeddings of identity features of the reference image; and generating, via a video generation model, the video in which the character appears with consistent likeness across multiple frames in accordance with the embeddings and the text prompt.
Clause 14. The method of Clause 13, further comprising generating, via a transformer, a joint multimodal embedding sequence based on concatenating the embeddings with text prompt embeddings associated with the text prompt.
Clause 15. The method of Clause 14, further comprising projecting the embeddings into a common latent space dimension of the video generation model prior to the concatenation with the text prompt embeddings.
Clause 16. The method of Clause 14, wherein the embeddings are concatenated with the text prompt embeddings via a learned gating mechanism that dynamically weights identity features relative to textual features.
Clause 17. The method of any one of Clauses 13-16, wherein the embeddings are injected into a cross-attention layer of the video generation model to condition hidden representations derived from the text prompt.
Clause 18. The method of any one of Clauses 13-17, further comprising generating multiple scenes with different inputs while maintaining the consistent likeness of the character across all scenes.
Clause 19. The method of any one of Clauses 13-18, wherein maintaining the consistent likeness comprises preserving one or more of facial expressions, hairstyle, clothing, or other distinguishing features of the reference image.
Clause 20. An apparatus comprising at least one means for performing any one of Clauses 13-19.
Clause 21. A computer program comprising code for causing an apparatus to perform any one of Clauses 13-19.
Clause 22. An apparatus comprising one or more processors, one or more memories coupled with the one or more processors, and instructions stored in the memory and operable, when executed by the one or more processors to cause the apparatus to perform any one of Clauses 13-19.
Clause 23. A method for editing a video, the method comprising: receiving an input video comprising a sequence of frames; receiving an editing instruction expressed in natural language; generating a multimodal condition based on the textual editing instruction and the input video, the multimodal condition comprising an embedding of the input video concatenated with an embedding of the textual editing instruction; applying, via a video editing model, the multimodal condition to modify visual content of the input video; and generating an edited video comprising visual modifications corresponding to the textual editing instruction, the edited video preserving temporal coherence and overall visual fidelity of the input video.
Clause 24. The method of Clause 23, wherein generating the multimodal condition comprises applying cross-attention between the embedding of the input video and the embedding of the textual editing instruction.
Clause 25. The method of any one of Clauses 23-24, further comprising generating the embedding of the input video based on encoding the sequence of frames via a temporal autoencoder.
Clause 26. The method of any one of Clauses 23-25, further comprising generating the embedding of the textual editing instruction based on encoding the instruction with a transformer-based language model.
Clause 27. The method of any one of Clauses 23-26, wherein the video editing model is conditioned on a task embedding corresponding to a type of editing operation comprising one or more of object addition, object removal, background replacement, or attribute modification.
Clause 28. The method of any one of Clauses 23-27, wherein generating the edited video further comprises animating newly generated content such that spatial and temporal consistency across multiple frames is preserved.
Clause 29. The method of any one of Clauses 23-28, wherein preserving temporal coherence comprises aligning positional embeddings of the sequence of frames such that edits applied to a first frame are propagated to subsequent frames.
Clause 30. The method of any one of Clauses 23-29, wherein the visual fidelity is preserved by applying a filtering stage configured to discard edited outputs that are less than a predetermined quality threshold determined by automated image editing metrics.
Clause 31. An apparatus comprising at least one means for performing any one of Clauses 23-30.
Clause 32. A computer program comprising code for causing an apparatus to perform any one of Clauses 23-30.
Clause 33. An apparatus comprising one or more processors, one or more memories coupled with the one or more processors, and instructions stored in the memory and operable, when executed by the one or more processors to cause the apparatus to perform any one of Clauses 23-30.
Clause 34. A method for generating synchronized audio for a video, the method comprising: receiving the video comprising a sequence of frames; receiving a text input describing one or more of a scene, an event, or a mood to be reflected in an audio track; generating a latent audio representation via an audio generation model conditioned jointly on video embeddings associated with the sequence of frames and text embeddings associated with the text input; and decoding the latent audio representation to produce an audio track temporally aligned with the video and semantically consistent with the text input.
Clause 35. The method of Clause 34, wherein the audio track comprises one or more of instrumental music, ambient sound, or sound effects.
Clause 36. The method of any one of Clauses 34-35, further comprising encoding the sequence of frames into video embeddings using a vision encoder, and encoding the text input into text embeddings using a language encoder.
Clause 37. The method of any one of Clauses 34-36, further comprising concatenating the video embeddings and text embeddings into a multimodal embedding sequence, wherein the audio generation model is conditioned on the multimodal embedding sequence.
Clause 38. The method of any one of Clauses 34-37, wherein decoding the latent audio representation comprises applying a variational autoencoder trained to reconstruct audio signals from compressed latent representations.
Clause 39. The method of any one of Clauses 34-38, wherein the audio context comprises at least one of: audio infilling, audio extension, or audio replacement for one or more frames of the video.
Clause 40. The method of any one of Clauses 34-39, wherein the semantic consistency is based on the correspondence between the generated audio and the text input using a contrastive audio-video-text pre-training model.
Clause 41. An apparatus comprising at least one means for performing any one of Clauses 34-40.
Clause 42. A computer program comprising code for causing an apparatus to perform any one of Clauses 34-40.
Clause 43. An apparatus comprising one or more processors, one or more memories coupled with the one or more processors, and instructions stored in the memory and operable, when executed by the one or more processors to cause the apparatus to perform any one of Clauses 34-40.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A method to edit a video, the method comprising:
receiving an input video comprising a sequence of frames;
receiving an editing instruction expressed in natural language;
generating a multimodal condition based on the textual editing instruction and the input video, the multimodal condition comprising an embedding of the input video concatenated with an embedding of the textual editing instruction;
applying, via a video editing model, the multimodal condition to modify visual content of the input video; and
generating an edited video comprising visual modifications corresponding to the textual editing instruction, the edited video preserving temporal coherence and overall visual fidelity of the input video.

2. The method of claim 1, wherein generating the multimodal condition comprises applying cross-attention between the embedding of the input video and the embedding of the textual editing instruction.

3. The method of claim 1, further comprising:
generating the embedding of the input video based on encoding the sequence of frames via a temporal autoencoder.

4. The method of claim 1, further comprising:
generating the embedding of the textual editing instruction based on encoding the instruction with a transformer-based language model.

5. The method of claim 1, wherein the video editing model is conditioned on a task embedding corresponding to a type of editing operation comprising one or more of object addition, object removal, background replacement, or attribute modification.

6. The method of claim 1, wherein generating the edited video further comprises animating newly generated content such that spatial and temporal consistency across multiple frames is preserved.

7. The method of claim 1, wherein preserving temporal coherence comprises aligning positional embeddings of the sequence of frames such that edits applied to a first frame are propagated to subsequent frames.

8. The method of claim 1, wherein the visual fidelity is preserved by applying a filtering stage configured to discard edited outputs that are leased than a predetermined quality threshold determined by automated image editing metrics.

9. An apparatus to edit a video, comprising:
one or more processors; and
one or more memories coupled with the one or more processors and storing processor-executable code that, when executed by the one or more processors, is configured to cause the apparatus to:
receive an input video comprising a sequence of frames;
receive an editing instruction expressed in natural language;
generate a multimodal condition based on the textual editing instruction and the input video, the multimodal condition comprising an embedding of the input video concatenated with an embedding of the textual editing instruction;
apply, via a video editing model, the multimodal condition to modify visual content of the input video; and
generate an edited video comprising visual modifications corresponding to the textual editing instruction, the edited video preserving temporal coherence and overall visual fidelity of the input video.

10. The apparatus of claim 9, wherein execution of the processor-executable code that causes the apparatus to generate the multimodal condition further causes the apparatus to apply cross-attention between the embedding of the input video and the embedding of the textual editing instruction.

11. The apparatus of claim 9, wherein execution of the processor-executable code further causes the apparatus to generate the embedding of the input video based on encoding the sequence of frames via a temporal autoencoder.

12. The apparatus of claim 9, wherein execution of the processor-executable code further causes the apparatus to generate the embedding of the textual editing instruction based on encoding the instruction with a transformer-based language model.

13. The apparatus of claim 9, wherein the video editing model is conditioned on a task embedding corresponding to a type of editing operation comprising one or more of object addition, object removal, background replacement, or attribute modification.

14. The apparatus of claim 9, wherein execution of the processor-executable code further that causes the apparatus to generate the edited video further causes the apparatus to animate newly generated content such that spatial and temporal consistency across multiple frames is preserved.

15. The apparatus of claim 9, wherein preserving temporal coherence comprises aligning positional embeddings of the sequence of frames such that edits applied to a first frame are propagated to subsequent frames.

16. The apparatus of claim 9, wherein the visual fidelity is preserved by applying a filtering stage configured to discard edited outputs that are leased than a predetermined quality threshold determined by automated image editing metrics.

17. A non-transitory computer-readable medium having program code recorded thereon for editing a video, the program code executed by one or more processors and comprising:
program code to receive an input video comprising a sequence of frames;
program code to receive an editing instruction expressed in natural language;
program code to generate a multimodal condition based on the textual editing instruction and the input video, the multimodal condition comprising an embedding of the input video concatenated with an embedding of the textual editing instruction;
program code to apply, via a video editing model, the multimodal condition to modify visual content of the input video; and
generate an edited video comprising visual modifications corresponding to the textual editing instruction, the edited video preserving temporal coherence and overall visual fidelity of the input video.

18. The non-transitory computer-readable medium of claim 17, wherein the program code to generate the multimodal condition further comprises program code to apply cross-attention between the embedding of the input video and the embedding of the textual editing instruction.

19. The non-transitory computer-readable medium of claim 17, wherein the program code further comprises program code to generate the embedding of the input video based on encoding the sequence of frames via a temporal autoencoder.

20. The non-transitory computer-readable medium of claim 17, wherein the program code further comprises program code to generate the embedding of the textual editing instruction based on encoding the instruction with a transformer-based language model.
